(19) United States
(12) Patent Application Publication
(10) Pub. No.: US 2026/0270061 A1
(43) Pub. Date: Sep. 10, 2026

(54) Associate Lattice Based Cryptography Construction per Confidentiality Category of Data to Ensure Quantum Resistance

(71) Applicant: Bank of America Corporation, Charlotte, NC (US)

(72) Inventors: Saurabh Arora, Haryana (IN); Sandeep Kumar Chauhan, Hyderabad (IN); Mallidi Bhagya Lakshmi Sudha Lavanya, Hyderabad (IN); Puneetha Polasa, Telangana (IN); Sanchit Taggar, New Delhi (IN)

(21) Appl. No.: 19/072,137

(22) Filed: Mar. 6, 2025

(51) Int. Cl. H04L 9/30; H04L 9/08; H04L 9/32

(52) U.S. Cl. CPC H04L 9/3093; H04L 9/088; H04L 9/3247

(57) ABSTRACT

A system and method for securing financial transactions using lattice-based cryptography, dynamic encryption selection, adaptive security validation, and authenticated access control are disclosed. The system classifies transaction risk using machine learning, selecting encryption based on security level, including legacy encryption, hybrid encryption, or lattice-based quantum-resistant encryption. Dynamic lattice parameter selection enhances encryption resilience, while quantum attack simulations validate security. Blockchain-based authentication, geo-fencing, and multi-factor digital signature verification control external access. Homomorphic encryption allows computations on encrypted data without decryption. Secure storage enforces access policies, and transport layer security protects transmitted data. The system continuously adapts encryption and authentication based on evolving threats, ensuring quantum-resistant, future-proof financial data protection. The invention enhances security by integrating artificial intelligence, quantum security validation, and decentralized authentication, preventing unauthorized access and ensuring regulatory compliance while enabling secure financial operations.

### TECHNICAL FIELD

The invention disclosed herein relates to the fields of cryptography and security, data processing and storage, multicomputer data transfer, and secure communications in computer networks. The invention applies lattice-based cryptographic constructions to protect sensitive financial data from both classical and quantum computing threats, ensuring data confidentiality and integrity through dynamic encryption schemes and digital signature layers. It also involves data processing and management, as it classifies, encrypts, and securely stores data in enterprise systems of record based on confidentiality levels and security requirements. Also, the invention addresses multicomputer data transfer, ensuring secure communication and data exchange between computing systems by incorporating post-quantum cryptographic encryption mechanisms to safeguard data in transit. It enhances network security by implementing quantum-resistant encryption layers that protect data from unauthorized access while enforcing cryptographic access controls for secure external authentication. By integrating these security and data management techniques, the invention strengthens enterprise-level cybersecurity protocols, preventing breaches and ensuring the long-term security of sensitive digital assets.

### DESCRIPTION OF THE RELATED ART

In the modern digital landscape, financial institutions generate and manage vast amounts of sensitive data, including customer transactions, account balances, authentication records, and other personally identifiable information. This data is essential for the seamless operation of banking systems, enabling real-time transactions, fraud detection, and compliance with regulatory requirements. However, as financial services increasingly migrate to digital platforms, the risk of data breaches and unauthorized access has grown significantly. Cybercriminals and malicious entities continually develop more sophisticated techniques to target vulnerabilities in existing security frameworks, posing a persistent threat to the confidentiality and integrity of financial data.

Traditional cryptographic methods have long been the backbone of secure data storage and transmission within financial institutions. These methods, primarily based on public-key cryptographic systems such as RSA and ECC, rely on the computational difficulty of mathematical problems like integer factorization and discrete logarithms. While these encryption schemes have been effective against classical computing threats, quantum computing presents an unprecedented challenge. Quantum computers, through algorithms like Shor's algorithm, can efficiently break these classical encryption schemes, making them obsolete and exposing sensitive financial data for potential attack.

As quantum computing technology continues to advance, the timeline for quantum-enabled attacks on financial systems becomes increasingly uncertain. While full-scale, fault-tolerant quantum computers may not yet be widely available, research and development in the field have accelerated significantly. Governments, financial institutions, and cybersecurity experts recognize that it is only a matter of time before quantum computers can decrypt vast amounts of encrypted data. This looming threat underscores the urgent need for financial institutions to adopt cryptographic solutions that remain secure in a post-quantum world.

Beyond the immediate concerns of quantum threats, financial data security faces more challenges from both external and internal actors. External cyber threats, including state-sponsored attacks, organized cybercrime groups, and individual hackers, continually seek to infiltrate financial networks and gain unauthorized access to encrypted data. Insider threats also pose a significant risk, as individuals with access to critical databases may try to misuse or expose confidential financial records. The existing encryption frameworks in place today struggle to adequately address both external and internal vulnerabilities in a scalable and sustainable manner.

Another pressing issue in financial data security is the complexity and heterogeneity of data classification. Financial institutions handle data of varying sensitivity levels, from general customer interaction logs to highly confidential transaction details. Applying uniform encryption across all types of financial data creates inefficiencies, as certain data may require stronger protection while other data can be adequately secured with traditional encryption methods. The lack of a tailored encryption approach results in increased computational overhead, making encryption and decryption processes slower and more resource intensive.

The challenge of implementing a scalable, efficient, and quantum-resistant encryption system is further compounded by regulatory and compliance requirements. Financial institutions must adhere to stringent data protection laws, including GDPR, PCI-DSS, and various banking regulations that mandate the protection of customer data. These regulations require encryption strategies that provide robust security and support seamless auditing, tracking, and controlled access for authorized entities. However, existing encryption mechanisms lack the flexibility needed to dynamically adapt to evolving regulatory demands while maintaining operational efficiency.

Another critical concern arises in the domain of data transmission. Financial data is often exchanged between internal banking systems, third-party financial applications, and external regulatory entities. During these transmissions, encrypted data is susceptible to interception, manipulation, and unauthorized decryption. Without adequate safeguards, malicious actors can target weaknesses in encryption protocols to gain unauthorized access to sensitive financial records. Ensuring secure data transmission requires cryptographic techniques that can withstand advanced attacks while maintaining compatibility with existing financial infrastructure.

Current encryption systems do not provide a seamless mechanism to assess and confirm encryption strength dynamically. Encryption algorithms must be regularly updated and tested to ensure their continued efficacy against emerging cyber threats. However, traditional cryptographic frameworks do not include a built-in mechanism to continuously confirm and adjust encryption parameters based on evolving computational threats. This lack of adaptability results in security gaps that can be targeted over time, making financial data increasingly vulnerable to sophisticated attacks.

Financial institutions also face significant challenges in key management, particularly in multi-user and multi-application environments. The complexity of managing public and private cryptographic keys across a vast network of banking applications increases the risk of key mismanagement, accidental exposure, and unauthorized access. Quantum computing further exacerbates this problem, as quantum-enabled attacks can target key generation and distribution mechanisms, making it imperative for financial systems to adopt secure cryptographic key management solutions.

The scalability of encryption systems presents another pressing issue. Financial institutions process an immense volume of transactions daily, requiring encryption solutions that can handle high-speed data processing without introducing latency or bottlenecks. Existing cryptographic frameworks often struggle to maintain both security and performance, leading to inefficiencies in banking operations. A quantum-resistant encryption approach must be designed to integrate seamlessly with existing financial systems without compromising speed, accessibility, or user experience.

An additional layer of complexity emerges when external applications and third-party financial service providers require access to encrypted data. While encryption ensures data confidentiality, it can also introduce challenges in controlled data sharing. Financial institutions need a mechanism that lets authorized third parties access specific encrypted data while preventing unauthorized decryption. Traditional encryption schemes do not offer an efficient way to enforce selective data access without compromising overall security.

The growing sophistication of cyber threats requires the implementation of cryptographic solutions that are resistant to forward-looking attacks. Even if financial data remains secure today, encrypted records stolen or intercepted can be stored and decrypted in the future when quantum computers become more powerful. This “harvest now, decrypt later” threat means that financial institutions must proactively adopt encryption methods that will remain secure well beyond the lifespan of current cryptographic systems.

Despite the urgent need for post-quantum cryptographic solutions, financial institutions have struggled to find a possible and scalable approach that integrates seamlessly with their existing security infrastructure. Many post-quantum cryptographic algorithms remain in the research phase, with limited real-world implementation strategies for financial applications. The challenge lies in developing a solution that is quantum-resistant and practical, efficient, and adaptable to various data classification needs.

Financial institutions also require encryption solutions that enable rapid and secure auditing of encrypted records. As regulatory scrutiny goes up, banks and financial service providers must be able to show compliance with data protection standards while making sure encrypted data remains accessible only to authorized entities. Existing encryption mechanisms often introduce operational complexities that hinder efficient auditing, increasing the risk of non-compliance with evolving regulatory mandates.

There has long been a critical and unmet need for a cryptographic solution that provides quantum resistance, scalable encryption, dynamic security validation, and seamless integration with financial systems. Traditional cryptographic methods are becoming obsolete in the face of quantum advancements, and financial institutions require a solution that ensures long-term data security without introducing inefficiencies. The lack of a unified encryption framework that classifies data based on confidentiality, applies quantum-resistant cryptography selectively, and continuously validates encryption strength has left financial institutions vulnerable to emerging cyber threats. Without an adaptable and future-proof encryption strategy, financial data security remains at significant risk, making the need for a transformative cryptographic solution more urgent than ever.

### SUMMARY OF THE INVENTION

The invention provides a system and method for implementing a cryptographic security framework that ensures financial data remains protected against both classical and quantum computational threats. Financial transactions, authentication logs, and account balances generate vast amounts of sensitive data, and the invention introduces a mechanism that dynamically determines the encryption method for each dataset based on its confidentiality category. By integrating traditional cryptographic schemes for less sensitive data and lattice-based encryption for high-risk information, the system optimizes security while maintaining efficiency. This approach enables financial institutions to continue operating within existing infrastructure while simultaneously future proofing their security architecture against emerging quantum threats.

The system evaluates the confidentiality of each data element by analyzing its origin, type, and potential impact in the event of unauthorized access. A bank account balance inquiry, for example, may not require the same level of security as a large-scale wire transfer involving multiple financial institutions. Similarly, a log of login attempts for an online banking portal may be of lower sensitivity than a record detailing all financial assets held by a customer. The invention makes sure data requiring the highest level of security is protected using lattice-based encryption, while lower-sensitivity data can continue to be encrypted with traditional public-key cryptographic methods.

Once the data classification is complete, the system determines the proper cryptographic technique for each dataset. Traditional cryptographic methods such as RSA, ECC, and AES are still used for standard data encryption, ensuring compatibility with legacy systems. However, when the system detects that the data is of high confidentiality, it applies lattice-based encryption. This encryption method is resistant to attacks from quantum computers, which would otherwise be capable of breaking traditional encryption using algorithms like Shor's algorithm. By selectively applying lattice-based cryptographic constructions only to the most sensitive data, the system optimizes computational resources and prevents unnecessary encryption overhead.

A fundamental part of the invention is its dynamic lattice parameter selection mechanism. Unlike traditional encryption techniques, which use predefined cryptographic parameters, this system customizes encryption parameters based on multiple factors, including the originating application, user identity, and data transaction details. For example, if a customer initiates a large funds transfer through a mobile banking application, the system can generate unique lattice parameters tailored to that specific transaction. If another transaction occurs within the same banking session, the system can apply a different set of parameters, making each encryption instance unique and resistant to replay attacks. This personalized encryption approach makes sure even if an attacker gains access to one encrypted dataset, it provides no insight into other encrypted records.

To make sure encrypted data remains secure even against evolving quantum computing threats, the invention includes a localized security validation mechanism. This process involves testing encrypted data against internal quantum computing simulations to evaluate whether it can be broken within a possible timeframe. If the system detects vulnerabilities in the lattice-based encryption parameters, it dynamically adjusts them to increase security complexity. For example, if a certain lattice configuration is susceptible to specific attack vectors, the system can increase the complexity of the lattice structure by changing parameters such as basis selection and noise distribution. This self-validating encryption methodology makes sure financial institutions maintain a continuously adaptive security posture.

Another aspect of the invention is its intelligent routing system, which makes sure data flows through the proper encryption pipeline based on predefined security policies. When financial data is generated, the system automatically finds whether it should be processed using legacy cryptographic techniques or quantum-resistant encryption. This routing mechanism operates in real time, letting financial institutions dynamically shift encryption strategies as security threats evolve. For example, if regulatory agencies mandate stronger encryption standards for specific financial transactions, the system can seamlessly transition those datasets to a lattice-based encryption model while maintaining backward compatibility with older records encrypted using traditional methods.

In addition to encryption, the invention incorporates a digital signature authentication layer to regulate external access to encrypted financial data. External applications such as third-party payment processors, regulatory agencies, and interbank clearing systems often require access to transaction records. To prevent unauthorized decryption of sensitive data, the invention uses a digital signature mechanism based on Crystals Dilithium, a lattice-based signature scheme. This makes sure external entities must present cryptographic proof of authenticity before gaining access to any encrypted records. For example, if a government agency requests access to encrypted banking transactions as part of a fraud investigation, it must first authenticate its request using a cryptographic signature that matches predefined access control policies. This additional security layer prevents data breaches and unauthorized disclosures.

The invention also addresses key management challenges by implementing a secure and scalable cryptographic key distribution framework. Traditional key management systems often struggle with distributing and updating cryptographic keys across large enterprise environments. The invention overcomes this issue by dynamically generating encryption keys that are unique to each transaction and securely distributing them through an enterprise security policy framework. For example, when an encrypted transaction is stored in a system of record, the decryption key is stored in a separate secure repository that is accessible only to authorized internal applications. This makes sure even if an attacker gains access to encrypted financial records, they cannot decrypt them without the corresponding key, which remains securely managed within the system.

An additional feature of the invention is its ability to perform secure computations on encrypted data without requiring decryption. By incorporating homomorphic encryption techniques, the system lets financial institutions analyze and process encrypted financial transactions without exposing them to potential security threats. For example, a fraud detection algorithm can analyze encrypted transaction patterns to identify suspicious behavior without needing to decrypt customer data. This privacy-preserving computation capability enhances security while letting financial institutions perform advanced analytics on sensitive records.

The invention is designed for seamless integration with existing financial systems and regulatory frameworks. Financial institutions operate within strict compliance environments that require adherence to data protection laws such as GDPR and PCI-DSS. The system includes built-in compliance enforcement mechanisms that ensure all encryption and data security policies align with regulatory standards. For example, if a financial institution must meet new encryption standards mandated by regulatory bodies, the system can automatically update encryption policies to reflect those requirements without disrupting existing operations.

To further enhance security, the system incorporates enterprise-level access control policies that regulate who can decrypt and access financial data. This fine-grained access control mechanism prevents unauthorized internal access, making sure even bank employees with database privileges cannot decrypt customer records without explicit permission. For example, if a bank teller requires access to a customer's transaction history, the system enforces an access policy that allows only read access without the ability to extract or change encrypted data.

The system makes sure data remains protected throughout its entire lifecycle, from generation to storage and transmission. Encrypted financial records are stored securely within enterprise databases, while data in transit is protected through secure communication channels. For example, when a customer initiates a transaction through an online banking portal, the encrypted data is securely transmitted to the bank's processing center, where it is stored in an encrypted format that meets quantum-resistant security standards.

A significant advantage of the invention is its ability to scale across large financial networks without introducing performance bottlenecks. By selectively applying lattice-based encryption only to high-risk data while using traditional encryption for lower-risk records, the system makes sure encryption operations do not slow down financial transactions. For example, a real-time stock trading platform can process thousands of transactions per second while selectively encrypting high-value trades with lattice-based cryptographic constructions, maintaining both security and performance.

The system also supports adaptive encryption policies, letting financial institutions customize encryption strategies based on business risk assessments. For example, if a bank determines that international wire transfers require the highest level of security, the system can enforce lattice-based encryption for those transactions while maintaining traditional encryption for domestic transactions. This adaptive approach makes sure encryption remains flexible and aligned with evolving security needs.

By integrating quantum-resistant encryption, dynamic security validation, enterprise access controls, and digital signature authentication, the invention provides a robust security framework for financial data protection. The system makes sure sensitive financial information remains secure against both current and future cyber threats while maintaining compatibility with existing financial infrastructure. This comprehensive approach to cryptographic security positions financial institutions to remain resilient in an era of rapidly advancing quantum computing capabilities.

The following provides a simplified summary of the present disclosure to offer a basic understanding of its various parts. This summary is not exhaustive, nor does it limit the exemplary parts of the inventions described. It is not designed to identify key or elements or steps of the disclosure, nor to define its scope. Rather, it is intended, as understood by a person of ordinary skill in the art, to introduce concepts of the disclosure in a simplified form as a precursor to the more detailed description that follows. The specification throughout this application has enough written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

The technical solution introduced by the invention establishes a highly sophisticated and adaptable encryption framework that ensures financial data remains protected against both classical and quantum computational threats. This solution provides a cryptographic system that dynamically determines and applies encryption techniques tailored to the confidentiality level of the data being processed. It integrates lattice-based encryption to safeguard sensitive financial records, while also implementing an additional layer of lattice-based digital signatures to authenticate and control access, particularly for external entities. The encryption methodology operates within an enterprise security framework, letting financial institutions implement quantum-resistant data protection strategies that align with existing data security rules, customer-specific attributes, and enterprise policies governing data storage and transmission.

The process begins with the system tracking and analyzing all actions taken by users interacting with enterprise applications, whether those applications are internally managed financial systems or external-facing platforms used by customers, vendors, or third-party service providers. Each user action generates financial data, which must be classified and secured based on its sensitivity and importance. The system evaluates various factors, including the transaction, the origin of the request, the involved financial accounts, and the security implications of potential unauthorized access. By analyzing these attributes, the system can categorize the data and assign an encryption method before storing it in an enterprise system of record. This classification process helps determine the most efficient and secure method of encryption, making sure the system remains highly optimized while providing the level of protection for different types of financial data.

Once data classification is complete, the system routes each dataset through an encryption decision pipeline that determines the level of cryptographic protection required. The routing process is governed by enterprise-wide data security rules that consider business segment classifications, regulatory compliance mandates, contractual obligations with financial partners, and institution-specific security policies. Less sensitive financial data, such as basic transaction logs, metadata related to non-confidential customer interactions, and general system activity records, may be encrypted using conventional cryptographic techniques. These traditional methods, such as RSA, ECC, and AES, provide enough protection for routine financial data while making sure encryption processes do not place unnecessary computational burdens on enterprise systems. The encrypted legacy data packets are then securely stored in the enterprise system of record, where they remain protected but accessible to authorized banking applications.

For highly confidential or sensitive financial data, the system does not rely on traditional encryption but instead invokes a lattice-based cryptographic construction to provide an enhanced level of security that is resistant to quantum computing attacks. This process begins with the choice of lattice parameters dynamically customized based on many security attributes. Unlike traditional encryption methods that use predefined key sizes and fixed cryptographic settings, this system generates unique lattice configurations tailored to each dataset's specific features. Factors such as the identity of the customer, the transaction details, the data originator module, and other metadata associated with the financial event all contribute to the choice of the lattice structure. This individualized approach makes sure every encryption instance remains unique, making it significantly more difficult for attackers to break the encryption, even if they gain access to multiple encrypted datasets.

To further enhance security, the system includes a localized lattice security validation mechanism that serves as a built-in process for testing encryption robustness. This validation system actively tries to break the lattice-encrypted data by simulating quantum computing attacks using available cryptographic analysis techniques. The system continuously tracks whether the applied encryption remains impenetrable under evolving computational capabilities. If a vulnerability is detected or if cryptographic strength needs enhancement, the system dynamically changes lattice parameters to increase encryption complexity and reinforce data security. This self-regulating cryptographic model makes sure encrypted financial records remain protected against future advancements in decryption methodologies, making the system adaptive and resilient in the face of evolving security challenges.

After encryption is applied, whether through traditional cryptographic methods or lattice-based encryption, the system securely stores the data within the enterprise system of record. The encrypted records are accessible only to authorized applications and individuals, making sure even if a malicious actor gains access to the database, they cannot decrypt or manipulate the protected financial records. Authorized banking applications, such as transaction processing engines and financial reporting tools, can decrypt and process the data only if they have cryptographic credentials. For lattice-encrypted records, applications must have access to the “Good Basis” information, which allows for secure decryption under approved enterprise security policies. Legacy-encrypted data is decrypted using conventional private keys maintained within the institution's secure key management infrastructure.

To provide an additional layer of security, particularly for external access to financial records, the system applies a digital signature mechanism based on lattice-based signature schemes. This makes sure external entities, such as third-party financial institutions, regulatory agencies, and authorized service providers, cannot access encrypted data unless they first authenticate their request using a quantum-resistant cryptographic signature. The digital signature mechanism, specifically designed using Crystals Dilithium, verifies the legitimacy of the entity asking for access and makes sure the encrypted data remains protected from unauthorized third parties. For example, if a government agency requires access to banking records as part of a regulatory audit, they must submit an authenticated cryptographic request verified by the system before any access is granted. This additional authentication layer prevents unauthorized disclosure while maintaining compliance with data-sharing agreements and regulatory obligations.

Incorporating a sophisticated cryptographic key management system, the invention also makes sure cryptographic keys remain secure and are dynamically generated, distributed, and updated as needed. Traditional encryption systems often struggle with key management, as large-scale banking environments require efficient and secure distribution of cryptographic keys across multiple applications and databases. The system introduced in this invention overcomes these challenges by generating encryption keys dynamically, making sure they remain unique to each transaction and dataset. The keys are securely stored within a separate protected repository, accessible only through tightly controlled enterprise security policies. Even if an adversary obtained an encrypted financial record, they could not decrypt it without access to the corresponding cryptographic key, which remains securely managed and isolated from the encrypted dataset itself.

Beyond traditional encryption, the system further enhances security by enabling homomorphic encryption capabilities, letting encrypted data be processed and analyzed without requiring decryption. This is beneficial for secure computations that need to be performed on sensitive financial data, such as fraud detection, risk analysis, and regulatory reporting. With this feature, financial institutions can execute complex data analytics and machine learning algorithms on encrypted transaction records without ever exposing sensitive financial details. For example, a bank could apply AI-driven fraud detection models to detect unusual transaction patterns without ever needing to decrypt individual customer records, thus maintaining security while enabling high-level data analysis.

The system is designed for seamless integration within enterprise banking environments, making sure financial institutions can implement this post-quantum cryptographic framework without requiring major overhauls to their existing infrastructure. Compliance with regulatory frameworks is built into the system, letting banks meet data protection mandates such as GDPR, PCI-DSS, and financial industry security requirements without additional manual oversight. The system automates encryption policy enforcement, making sure all financial records are encrypted under industry standards while maintaining audit trails for regulatory review. If a new security standard is introduced, the system can automatically adapt encryption policies to align with updated regulatory guidelines, ensuring ongoing compliance without disrupting business operations.

The invention also incorporates enterprise-wide access control policies that govern which individuals and applications have permission to decrypt financial records. Fine-grained access control mechanisms regulate how encrypted data can be accessed, making sure even internal employees with database access cannot retrieve confidential financial information without proper permission. If a bank employee requires access to specific transaction data, the system enforces role-based security policies that allow only limited access privileges based on predefined security requirements. This makes sure encryption protects data from external threats and prevents unauthorized internal access.

By combining quantum-resistant encryption, self-validating cryptographic security, digital signature authentication, adaptive key management, and enterprise access control mechanisms, the invention provides a comprehensive security framework that protects financial institutions from both current and future cyber threats. The system makes sure financial data remains encrypted throughout its entire lifecycle, from the moment it is generated to its secure storage in enterprise systems and eventual controlled access by authorized entities. This approach makes sure financial institutions remain resilient against evolving cyber threats while maintaining operational efficiency and compliance with regulatory mandates. Through its advanced cryptographic innovations, the invention positions financial institutions to navigate the transition into the quantum computing era with confidence in the security of their sensitive financial data.

The invention introduces a cryptographic security framework that incorporates lattice-based encryption to provide enterprise data security with a level of robustness that is resistant to quantum computing threats. Unlike conventional encryption methods that depend on mathematical problems such as integer factorization or elliptic curve computations, which can be efficiently solved by quantum computers using algorithms like Shor's algorithm, this system leverages the inherent complexity of lattice-based cryptographic structures. Lattice-based encryption is based on hard mathematical problems, such as the Shortest Vector Problem (SVP) and the Learning With Errors (LWE) problem, which remain computationally infeasible to solve, even with advanced quantum computing capabilities. Using this approach, the system makes sure all sensitive financial data, authentication credentials, and proprietary banking transactions remain protected against emerging decryption techniques that target quantum computational power.

A key element of this invention is the implementation of additional digital signatures designed to reinforce the security of both internal and external access scenarios. Digital signatures provide authentication mechanisms that ensure only verified entities can access encrypted financial data. The invention incorporates lattice-based signature schemes, such as Crystals Dilithium, which offer quantum resistance, making sure external applications, third-party service providers, and regulatory agencies must authenticate themselves using cryptographically secure, quantum-resistant methods before gaining access to encrypted datasets. This additional layer of security is essential for preventing unauthorized access attempts, particularly where adversaries may gain physical or remote access to encrypted records. Even if an unauthorized party intercepts an encrypted communication or gains access to a database containing encrypted financial data, they cannot decrypt it without the corresponding quantum-resistant authentication signature.

One of the unique parts of this invention is the dynamic lattice construction mechanism, which generates encryption parameters on a per-event basis. Unlike traditional encryption frameworks that rely on static cryptographic parameters, this system customizes lattice-based encryption parameters dynamically based on many security-relevant factors. These factors include customer-specific information, event metadata, financial transaction type, and the application module that started the encryption process. This approach makes sure each encrypted data segment has a unique cryptographic structure, making it difficult for attackers to generalize decryption strategies. Even if an attacker obtains an encrypted dataset, they could not use the same attack strategy on different encrypted records because each encryption event has a uniquely constructed lattice parameter set. This enhances the overall security of financial transactions and prevents sophisticated adversaries from leveraging stolen or leaked encryption keys to compromise multiple records.

Another novel feature of this system is the integration of a localized, configurable lattice encryption validation system. This part makes sure encryption parameters are continuously evaluated and updated as needed to maintain security against evolving threats. The system includes a built-in security validation mechanism that tries to break its own encryption using simulated quantum computing attacks. If any weaknesses are identified in the encryption structure, the system dynamically adjusts the lattice parameters to increase complexity and fortify security. This real-time validation process makes sure encrypted financial records remain resistant to both classical and quantum cryptographic attacks. Unlike traditional cryptographic frameworks that require manual reconfiguration when security vulnerabilities are detected, this invention automates the entire security validation process, making sure encryption remains strong even as computational threats evolve.

An additional core feature of the invention is its ability to handle various data classifications and assign the proper level of encryption based on the sensitivity of each dataset. The system distinguishes between lower-risk data, which can be adequately protected using conventional public-key cryptographic techniques, and high-risk, confidential financial data, which requires quantum-resistant lattice-based encryption. This classification process makes sure financial institutions do not spend unnecessary computational resources encrypting low-risk data with the highest levels of security, thus optimizing encryption performance while maintaining strong data protection. The ability to selectively apply quantum-resistant encryption only to high-risk datasets makes sure the system remains computationally efficient while providing an unparalleled level of security for financial transactions.

One of the most non-obvious parts of this invention is its capability to dynamically adapt cryptographic protocols based on individual events. Traditional encryption models apply static cryptographic settings across all transactions, despite context. This system, however, assesses the confidentiality level of each event and applies customized encryption settings that correspond to the level of risk associated with the transaction. For example, an ordinary account balance inquiry may be encrypted using traditional RSA or AES encryption, but a high-value wire transfer between international financial institutions may automatically trigger lattice-based encryption with more layers of complexity. This event-driven cryptographic adaptation makes sure financial institutions apply the most appropriate security measures to each specific transaction while optimizing encryption speed and computational efficiency.

Another non-obvious feature of the invention is the ability to configure lattice encryption settings dynamically and perform localized lattice security validation. Unlike conventional cryptographic frameworks that require predefined encryption settings, this system continuously evaluates the effectiveness of its encryption configurations by running internal security tests that simulate advanced decryption attempts. If the encryption strength is insufficient against projected quantum computing capabilities, the system automatically adjusts lattice parameters to enhance security. This makes sure encryption configurations are never static but evolve dynamically based on real-world cryptographic threats and enterprise security requirements. This continuous self-optimization process prevents encryption vulnerabilities from being targeted while making sure financial data remains protected against future computational advancements.

A further inventive feature of the invention is the integration of enterprise data security rules to guide encryption parameter selection and routing decisions. Conventional cryptographic models typically apply uniform encryption policies across all datasets, failing to consider the specific security requirements of different data elements. This invention makes sure each data segment is evaluated individually and secured using the most appropriate encryption technique based on its classification, regulatory requirements, and business impact. The system analyzes metadata associated with each dataset-including transaction type, customer identity, business segment, and access history-to determine the best encryption method. This intelligent encryption routing system prevents financial institutions from applying one-size-fits-all encryption strategies, making sure each dataset receives the most suitable level of protection.

Unlike traditional security frameworks that rely on manual intervention for encryption updates and access management, this invention automates security updates, parameter changes, and authentication protocols in response to real-time security assessments. This ability to automate cryptographic enhancements makes sure financial institutions remain ahead of evolving cybersecurity threats without requiring manual cryptographic reconfiguration. Additionally, integrating lattice-based digital signatures makes sure both data confidentiality and access authentication are managed under a unified cryptographic framework, strengthening security without introducing more complexity.

Through its combination of quantum-resistant encryption, dynamic cryptographic adaptation, real-time security validation, event-driven encryption routing, and self-optimizing lattice parameter selection, this invention establishes a comprehensive security model for enterprise financial data protection. Unlike existing security solutions that rely on static encryption models, this system makes sure encryption settings dynamically evolve in response to security threats while maintaining computational efficiency. By safeguarding sensitive financial transactions, authentication credentials, and regulatory compliance records against both classical and quantum decryption methods, this invention provides a future-proof cryptographic solution that ensures financial data security remains intact even as quantum computing capabilities continue to advance.

Applying this invention is beneficial for financial institutions, which must navigate an increasingly complex cybersecurity landscape while ensuring regulatory compliance and maintaining operational efficiency. Banks, payment processors, and financial service providers face the challenge of securing high-value transactions, protecting customer information, and preventing data breaches, all while making sure encryption does not introduce latency or degrade system performance. This invention addresses these challenges by enabling financial institutions to selectively apply the strongest cryptographic techniques to their most sensitive data while maintaining compatibility with existing security infrastructure.

The invention also ensures long-term compliance with evolving regulatory standards by implementing security policies that automatically adjust encryption techniques to meet new cybersecurity mandates. If regulatory agencies introduce updated encryption requirements, the system can seamlessly integrate those requirements into its security framework without disrupting ongoing operations. This proactive approach to regulatory compliance makes sure financial institutions can meet security obligations without the need for costly or disruptive system overhauls.

Through its innovative combination of lattice-based encryption, quantum-resistant digital signatures, automated encryption validation, and event-driven cryptographic adaptation, this invention establishes a next-generation security framework that addresses the need for post-quantum financial data protection. By making sure encryption remains adaptive, efficient, and impenetrable even in the face of evolving cybersecurity threats, this system provides an unparalleled level of data protection for enterprise financial institutions, safeguarding sensitive financial records from both current and future decryption threats.

In some arrangements, a method for securing financial data using lattice-based cryptography, dynamic encryption selection, adaptive security validation, and authenticated access control includes receiving, by a data classification module, a data transaction request that includes transaction metadata and financial data associated with a user. The transaction metadata comprises at least a transaction type, a transaction amount, an originating application identifier, and a user identifier. The method further includes analyzing, by the data classification module, the transaction metadata to determine a confidentiality classification of the financial data based on enterprise security policies. The analyzing step includes applying a machine learning model trained on historical transaction data to dynamically assess risk levels associated with the financial data. The machine learning model is trained using at least one of user transaction patterns, fraud detection indicators, geolocation data, device fingerprints, and real-time cybersecurity threat intelligence.

The method further includes selecting, by an encryption routing module, an encryption method for securing the financial data based on the confidentiality classification and the dynamically assessed risk level. The selecting step includes applying legacy encryption to the financial data using a public-key encryption algorithm when the confidentiality classification is a low-security classification. The selecting step also includes starting a lattice-based encryption process for the financial data when the confidentiality classification is a high-security classification, wherein the encryption routing module increases the complexity of the selected encryption method in response to a higher risk score generated by the machine learning model.

The method further includes generating, by a lattice parameter selection module, dynamic lattice parameters customized based on at least one of the user identifier, the transaction type, the transaction amount, the originating application identifier, and the confidentiality classification. The generating step includes selecting a lattice dimension and modulus based on the confidentiality classification, wherein higher-security classifications result in larger lattice dimensions and higher modulus values. The generating step also includes determining a lattice basis using a combination of transaction-specific metadata and enterprise-defined encryption policies. The generating step further includes generating a noise distribution function specific to the financial data, wherein the noise distribution function is changed based on an adaptive security model that continuously refines noise levels in response to evolving quantum computing threats.

The method further includes encrypting, by a lattice encryption module, the financial data using the dynamic lattice parameters. The encrypting step includes transforming the financial data into a lattice vector representation. The encrypting step also includes applying the lattice basis and the noise distribution function to the lattice vector representation to generate an encrypted lattice structure. The encrypting step further includes storing the encrypted lattice structure in an enterprise system of record along with metadata identifying the encryption parameters.

The method further includes validating, by a security validation module, the strength of the encrypted lattice structure using a quantum attack simulation. The validating step includes executing a plurality of simulated quantum decryption attempts using different quantum attack models, including but not limited to Shor's algorithm and Grover's search algorithm. The validating step also includes analyzing results of the quantum decryption attempts to determine whether the encrypted lattice structure is susceptible to decryption. The validating step further includes, when the encrypted lattice structure is determined to be susceptible, applying a security reinforcement algorithm that iteratively increases the lattice complexity until quantum attack simulations fail to break the encryption.

The method further includes storing, by a secure storage module, the encrypted financial data in an enterprise database configured to enforce access control policies for decryption requests. The method further includes receiving, by an external access control module, a decryption request from an external entity to access the encrypted financial data, wherein the decryption request includes an authentication signature and at least two authentication factors selected from a cryptographic key, a biometric identifier, a time-sensitive authentication code, or a blockchain-verified identity signature.

The method further includes authenticating, by a digital signature verification module, the external entity based on the authentication signature and authentication factors. The authenticating step includes verifying the authentication signature using a lattice-based digital signature scheme. The authenticating step also includes authorizing access to the encrypted financial data upon successful verification of the authentication signature and at least one additional authentication factor.

The method further includes retrieving, by a secure access module, the encrypted financial data from the enterprise database in response to the authorized decryption request. The method further includes decrypting, by a lattice decryption module, the encrypted financial data using the corresponding lattice parameters. The decrypting step includes applying an inverse lattice transformation to convert the encrypted lattice structure into a lattice vector representation. The decrypting step also includes removing the noise distribution function from the lattice vector representation. The decrypting step further includes reconstructing the original financial data from the decrypted lattice vector representation.

The method further includes encrypting, by a post-decryption security module, the decrypted financial data using a homomorphic encryption scheme before transmission to the external entity, wherein the homomorphic encryption scheme enables computations to be performed on the encrypted financial data while maintaining its confidentiality. The method further includes providing, by an access delivery module, the homomorphically encrypted financial data to the external entity in response to the authorized decryption request, thereby ensuring that access to sensitive financial information is secured against both classical and quantum cryptographic attacks.

In some arrangements, the method further includes applying, by the data classification module, a real-time anomaly detection model to compare the transaction metadata against historical transaction patterns to identify potentially fraudulent transactions before encryption selection. The anomaly detection model detects deviations from normal user behavior and flags transactions with unusual characteristics that may indicate fraudulent activity. The anomaly detection model operates in conjunction with the machine learning model to refine the confidentiality classification and adjust the encryption method selection accordingly.

In some arrangements, the method further includes selecting, by the encryption routing module, a hybrid encryption method when the transaction metadata indicates a medium-security classification, wherein the hybrid encryption method comprises encrypting the financial data using both a public-key encryption algorithm and a lattice-based encryption algorithm to provide layered security. The encryption routing module determines that certain transactions require dual encryption for added protection against both classical and quantum threats. The hybrid encryption method ensures that even if one encryption layer is compromised, the financial data remains secure under the second encryption scheme.

In some arrangements, the method further includes customizing, by the lattice parameter selection module, the dynamic lattice parameters based on real-time cybersecurity threat intelligence data, wherein the threat intelligence data includes known cryptographic attack vectors and active quantum computing developments. The lattice parameter selection module continuously updates encryption configurations by incorporating the latest security threat reports from global cybersecurity agencies, ensuring that encryption parameters evolve to counter emerging attack methodologies. This customization process enhances the security of the lattice-based encryption by making it resistant to newly identified vulnerabilities.

In some arrangements, the method further includes executing, by the security validation module, a multi-tiered security assessment framework, wherein the multi-tiered security assessment framework applies different levels of quantum attack simulations based on enterprise security policies, including standard, enhanced, and critical security validation levels. The security validation module assigns different security assessment levels based on the sensitivity of the encrypted financial data and the associated risk factors. Transactions classified as highly confidential undergo enhanced or critical security validation, which involves more rigorous quantum attack simulations and deeper cryptographic integrity tests.

In some arrangements, the method further includes utilizing, by the secure storage module, a distributed storage architecture, wherein encrypted financial data is stored redundantly across multiple secure enterprise storage nodes to ensure data integrity and prevent unauthorized centralized access. The secure storage module distributes encrypted financial records across multiple geographically dispersed storage servers, ensuring that no single point of failure can compromise the security of stored data. The distributed storage architecture protects against data breaches and enhances resilience against cyberattacks targeting centralized storage systems.

In some arrangements, the method further includes enforcing, by the external access control module, a geo-fencing security policy that restricts decryption requests based on the geographical location of the external entity, wherein decryption requests originating from unauthorized geographic regions are denied. The external access control module determines the geographic origin of each decryption request and cross-references it with predefined security policies to prevent access from unauthorized regions. This geo-fencing mechanism ensures that sensitive financial data remains protected from cyber threats originating from high-risk geographic locations.

In some arrangements, the method further includes implementing, by the digital signature verification module, a blockchain-based verification mechanism, wherein authentication signatures are recorded on an immutable blockchain ledger to provide tamper-resistant authentication tracking for external decryption requests. The blockchain-based verification mechanism ensures that each authentication signature is cryptographically recorded, preventing unauthorized modifications or forgeries. This enhances the security of external access control by ensuring that authentication logs remain immutable and verifiable.

In some arrangements, the method further includes encrypting, by the access delivery module, the homomorphically encrypted financial data using a transport layer security protocol before transmission to the external entity, ensuring end-to-end security for sensitive financial data during network communication. The access delivery module applies an additional layer of encryption using a transport layer security protocol to protect financial data from interception or manipulation during transmission over external networks. This final security measure ensures that encrypted financial records remain protected even as they travel through potentially vulnerable communication channels.

In some arrangements, the system further includes the data classification module applying a real-time anomaly detection model to compare the transaction metadata against historical transaction patterns to identify potentially fraudulent transactions before encryption selection. The anomaly detection model detects deviations from normal user behavior and flags transactions with unusual characteristics that may indicate fraudulent activity. The anomaly detection model operates in conjunction with the machine learning model to refine the confidentiality classification and adjust the encryption method selection accordingly.

In some arrangements, the system further includes the encryption routing module selecting a hybrid encryption method when the transaction metadata indicates a medium-security classification, wherein the hybrid encryption method comprises encrypting the financial data using both a public-key encryption algorithm and a lattice-based encryption algorithm to provide layered security. The encryption routing module determines that certain transactions require dual encryption for added protection against both classical and quantum threats. The hybrid encryption method ensures that even if one encryption layer is compromised, the financial data remains secure under the second encryption scheme.

In some arrangements, the system further includes the lattice parameter selection module customizing the dynamic lattice parameters based on real-time cybersecurity threat intelligence data, wherein the threat intelligence data includes known cryptographic attack vectors and active quantum computing developments. The lattice parameter selection module continuously updates encryption configurations by incorporating the latest security threat reports from global cybersecurity agencies, ensuring that encryption parameters evolve to counter emerging attack methodologies. This customization process enhances the security of the lattice-based encryption by making it resistant to newly identified vulnerabilities.

In some arrangements, the system further includes the security validation module executing a multi-tiered security assessment framework, wherein the multi-tiered security assessment framework applies different levels of quantum attack simulations based on enterprise security policies, including standard, enhanced, and critical security validation levels. The security validation module assigns different security assessment levels based on the sensitivity of the encrypted financial data and the associated risk factors. Transactions classified as highly confidential undergo enhanced or critical security validation, which involves more rigorous quantum attack simulations and deeper cryptographic integrity tests.

In some arrangements, the system further includes the secure storage module utilizing a distributed storage architecture, wherein encrypted financial data is stored redundantly across multiple secure enterprise storage nodes to ensure data integrity and prevent unauthorized centralized access. The secure storage module distributes encrypted financial records across multiple geographically dispersed storage servers, ensuring that no single point of failure can compromise the security of stored data. The distributed storage architecture protects against data breaches and enhances resilience against cyberattacks targeting centralized storage systems.

In some arrangements, the system further includes the external access control module enforcing a geo-fencing security policy that restricts decryption requests based on the geographical location of the external entity, wherein decryption requests originating from unauthorized geographic regions are denied. The external access control module determines the geographic origin of each decryption request and cross-references it with predefined security policies to prevent access from unauthorized regions. This geo-fencing mechanism ensures that sensitive financial data remains protected from cyber threats originating from high-risk geographic locations.

In some arrangements, the system further includes the digital signature verification module implementing a blockchain-based verification mechanism, wherein authentication signatures are recorded on an immutable blockchain ledger to provide tamper-resistant authentication tracking for external decryption requests. The blockchain-based verification mechanism ensures that each authentication signature is cryptographically recorded, preventing unauthorized modifications or forgeries. This enhances the security of external access control by ensuring that authentication logs remain immutable and verifiable.

In some arrangements, the system further includes the access delivery module encrypting the homomorphically encrypted financial data using a transport layer security protocol before transmission to the external entity, ensuring end-to-end security for sensitive financial data during network communication. The access delivery module applies an additional layer of encryption using a transport layer security protocol to protect financial data from interception or manipulation during transmission over external networks. This final security measure ensures that encrypted financial records remain protected even as they travel through potentially vulnerable communication channels.

The following description and claims, in conjunction with the drawings-all integral parts of this specification-will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 is an exemplary system architecture diagram in accordance with one or more embodiments disclosed herein that illustrates a sample, secure, financial-transaction, processing system integrating lattice-based cryptography, dynamic encryption selection, quantum-resistant security validation, and authenticated access control. The system includes interconnected modules for transaction classification, encryption routing, lattice parameter generation, secure storage, quantum attack simulation, blockchain-based authentication, and homomorphic encryption to ensure end-to-end financial data protection.

FIG. 2 is an exemplary flow diagram in accordance with one or more embodiments disclosed herein that illustrates a sample step-by-step process of securing financial transactions using dynamic encryption selection, lattice-based cryptography, and adaptive security validation. The flow includes transaction classification, encryption method selection, quantum attack simulation, blockchain-based authentication, controlled decryption, and secure data transmission to ensure end-to-end protection against unauthorized access and quantum computing threats.

FIGS. 3A-3D collectively illustrate an exemplary sequence diagram in accordance with one or more embodiments disclosed herein that illustrates the interactions between system components for processing, encrypting, validating, storing, decrypting, and securely transmitting financial transaction data. The sequence includes user-initiated transactions, risk classification, encryption routing, lattice-based parameter selection, quantum security validation, authentication via blockchain-based verification, controlled decryption, and secure delivery of financial data to authorized entities.

FIGS. 4A and 4B are exemplary class diagrams in accordance with one or more embodiments disclosed herein that illustrates the structural relationships between various system components for securing financial transactions using lattice-based cryptography, dynamic encryption selection, and adaptive security validation. The diagrams defines key classes, including transaction processing, encryption modules, security validation, authentication mechanisms, secure storage, and access control, along with their attributes, methods, and interconnections to ensure quantum-resistant data protection and regulatory compliance.

FIG. 5 is an exemplary context diagram in accordance with one or more embodiments disclosed herein that illustrates the integration of multiple cryptographic techniques, including traditional encryption, lattice-based encryption, digital signatures, homomorphic encryption, and cryptographic hash functions, to secure financial transaction data throughout its lifecycle. The diagram highlights the interaction between customer devices, secure data storage, encryption mechanisms, and access control policies to ensure quantum-resistant protection for financial transactions.

FIG. 6 is an exemplary technical details summary in accordance with one or more embodiments disclosed herein that illustrates the encryption, classification, validation, and storage processes used to secure financial transaction data. The diagram highlights the integration of lattice-based cryptography, dynamic encryption parameter selection, quantum-resistant security validation, and controlled external access mechanisms to ensure financial data remains protected throughout its lifecycle.

### DETAILED DESCRIPTION

The invention provides a highly secure system and method for encrypting, validating, storing, and accessing financial data using lattice-based cryptography, dynamic encryption selection, adaptive security validation, and authenticated access control. The system is designed to protect sensitive financial transactions against both classical and quantum computing threats by implementing multiple layers of security, including quantum-resistant encryption, multi-tier authentication, blockchain-based verification, and geo-fencing access restrictions. The invention ensures that financial data remains encrypted while still letting computations be performed on encrypted data when necessary, thus enhancing security while maintaining operational efficiency.

The system begins when a user makes a financial transaction through a computing device such as a mobile phone, banking kiosk, ATM, or enterprise workstation. This transaction request includes metadata such as transaction type, transaction amount, originating application, user identifier, timestamp, and geographic location. The transaction processing system receives the request and forwards it to the data classification module, which is responsible for analyzing the transaction's risk level. The classification process is aided by a machine learning model trained on historical transaction data, fraud detection patterns, and real-time cybersecurity threat intelligence. This model continuously adapts to emerging threats, making sure financial transactions are classified with high accuracy.

Based on the classification results, the system assigns a security level to the transaction, categorizing it as low-security, medium-security, or high-security. Low-security transactions typically include routine banking activities such as balance inquiries or small transfers, while medium-security transactions may include vendor payments or payroll processing. High-security transactions involve large-scale financial transfers, regulatory-sensitive data, or corporate transactions that require the highest level of encryption and access control. Once classified, the encryption routing module determines the encryption method based on the assigned security level.

For low-security transactions, the system applies legacy encryption methods such as RSA, AES, or ECC, which are suitable for protecting less sensitive financial data while ensuring compatibility with existing systems. Medium-security transactions undergo hybrid encryption, which combines both public-key encryption and lattice-based encryption to provide an additional layer of security. This makes sure even if one encryption scheme is compromised, the data remains protected under another encryption algorithm. High-security transactions are encrypted using lattice-based cryptography, a quantum-resistant encryption technique that protects financial data from both current and future cryptographic attacks.

Before encrypting high-security transactions, the system generates dynamic lattice encryption parameters specific to each transaction. These parameters are determined based on various factors, including user identity, transaction type, transaction amount, originating application, and enterprise-defined security policies. The lattice basis generator constructs the mathematical lattice structure, while the noise distribution generator introduces a randomized noise function that further strengthens encryption. These steps make sure every encrypted transaction is uniquely configured, making it highly resistant to decryption attempts.

Once the encryption parameters are established, the lattice encryption module converts the financial data into an encrypted lattice structure, making sure it remains protected from unauthorized access. The encrypted financial data is then stored in a secure storage module that enforces strict access control policies. The system continuously confirms encryption robustness by performing quantum attack simulations, leveraging decryption techniques such as Shor's algorithm and Grover's search algorithm to test whether the encrypted data is vulnerable to quantum-based decryption attempts. If a vulnerability is detected, the system dynamically updates encryption configurations, increasing lattice complexity, changing modulus values, or introducing more security layers to reinforce encryption strength.

When an external entity requests access to encrypted financial data, the external access control module verifies whether the request complies with enterprise security policies. To prevent unauthorized access, the system enforces geo-fencing security policies that restrict decryption requests based on geographic location. Requests originating from unauthorized regions are automatically denied to reduce the risk of cyber threats. If the request is within an authorized location, the external entity must undergo digital signature verification before access is granted.

The system makes sure all external authentication requests are confirmed using a lattice-based digital signature scheme. This step confirms that the asking for entity has the correct cryptographic credentials before data access is allowed. To further enhance security, the system retrieves authentication records from a blockchain-based verification module, making sure access logs remain immutable and tamper-resistant. By leveraging blockchain technology, the system prevents unauthorized changes to authentication records, reducing the risk of identity forgery and unauthorized access.

If the requestor successfully passes authentication, the secure access module retrieves the encrypted financial data from the secure storage module. The data is then sent to the lattice decryption module, which applies an inverse lattice transformation to reconstruct the original financial data. The decryption process involves removing the noise function and restoring the financial data to its original state. To maintain data security even after decryption, the system applies homomorphic encryption, letting computations be performed on encrypted data while preserving confidentiality. This makes sure financial institutions can process encrypted records without exposing raw transaction details.

Before transmitting decrypted financial data to an external entity, the access delivery module makes sure all outgoing data meets security requirements. To prevent unauthorized interception, the transport layer security module encrypts the transmission using secure communication protocols such as TLS. This step makes sure sensitive financial data remains protected while being transmitted over public or private networks, preventing unauthorized access during data transmission.

The invention provides a highly adaptable security framework that dynamically adjusts encryption and authentication mechanisms based on risk assessments. By continuously refining encryption parameters, tracking cybersecurity threats, and updating authentication policies, the system makes sure financial data remains protected against both conventional and emerging threats. Integrating lattice-based encryption, blockchain verification, geo-fencing, homomorphic encryption, and quantum attack simulation provides a comprehensive security solution that is resilient to advanced cyber threats.

The modular nature of the system lets it be easily integrated into existing financial infrastructures, providing a scalable security architecture for banks, financial institutions, government agencies, and corporate enterprises. The ability to classify transactions in real-time, select ideal encryption methods, and adapt security configurations based on quantum threat intelligence makes this invention highly future-proof. Incorporating machine learning enhances security accuracy by detecting and mitigating fraudulent activities before they occur.

The system's end-to-end security measures make sure financial data remains confidential and secure from the moment a transaction is started to its final transmission. Using lattice-based cryptography guarantees long-term security against quantum computing advancements, while homomorphic encryption lets financial data be processed securely without exposing sensitive records. By leveraging blockchain-based verification, the system prevents authentication fraud and ensures the integrity of access control policies.

This invention introduces a transformative approach to securing financial transactions by implementing an adaptive and intelligent security framework. The ability to simulate quantum decryption attempts and dynamically update encryption configurations makes sure financial institutions remain one step ahead of emerging cyber threats. The multi-layered security model provides unparalleled protection for financial records, reducing the risks associated with data breaches, identity theft, and unauthorized access.

With the increasing threat posed by quantum computing to traditional encryption methods, this invention provides a future-proof solution by implementing lattice-based cryptography that remains resistant to quantum decryption techniques. The seamless integration of post-quantum encryption, blockchain authentication, homomorphic encryption, and access control mechanisms makes this system one of the most advanced financial security solutions available.

The ability to selectively enforce encryption based on transaction risk level makes sure the system remains efficient while focusing on high-security encryption for critical transactions. The system's ability to classify and encrypt transactions in real-time makes sure financial institutions can operate securely without sacrificing performance or operational efficiency. By enforcing geo-fencing and multi-factor authentication, the system makes sure only authorized users from approved locations can access encrypted financial records.

This invention represents a groundbreaking advancement in financial data security, providing a comprehensive, scalable, and adaptive solution to protect sensitive transactions from unauthorized access and emerging quantum threats. The combination of advanced cryptographic techniques, dynamic security configurations, blockchain authentication, and homomorphic encryption makes sure financial institutions can maintain compliance with regulatory standards while safeguarding transaction integrity. The invention addresses current and future security challenges, providing a highly resilient, efficient, and secure financial transaction system.

The description of various example embodiments herein is intended to meet the goals previously outlined, referencing the illustrations in this disclosure. These illustrations depict multiple systems and methods for implementing the disclosed information. Alternative implementations are possible, and changes to both structure and functionality may be made. The description details various connections between elements, which should be interpreted broadly. Unless explicitly stated otherwise, these connections can be direct or indirect and may be established through either wired or wireless methods. This document does not restrict the nature of these connections.

In various configurations, terms such as “computers” and “machines” refer to devices that may be general-purpose or specialized for specific tasks, whether physical or virtual, and capable of network connectivity. These devices encompass all necessary hardware, software, and parts known to skilled practitioners, including application-specific integrated circuits (ASICs), microprocessors, cores, or other processing units. These parts execute, control, or implement various types of software, instructions, data, modules, processes, or routines. The terms used do not restrict the device type and should be broadly interpreted. Software, data, and executable code can live on various physical, computer-readable storage devices, such as local memory, cloud-based storage, or network-attached storage. These can be stored in both volatile and non-volatile memory and may function autonomously or respond to specific triggers. These elements can be combined or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks use various hardware and software parts, including modems, routers, firewalls, switches, and adapters, to help with communication. Networks are also equipped with virtual IP addresses and support multiple protocols like HTTPS, enabling effective packet-based data transmission and communication.

Several types of artificial intelligence apply to implementing different parts of the invention. Each type of artificial intelligence provides specific functionalities that enhance security, optimize encryption methods, improve fraud detection, and enable secure financial transactions. Below explains the AI types applicable to the invention, including their definitions, relevance to specific parts of the invention, and examples of how they can be implemented.

Machine Learning (ML) is a branch of artificial intelligence that enables systems to learn from data and make predictions or decisions without explicit programming. Machine learning models use statistical techniques to find patterns in financial transaction data, detect anomalies, and classify risk levels. In this invention, machine learning applies to transaction classification, fraud detection, encryption selection, and security risk assessment. Supervised learning models can be trained on historical financial transactions to classify them into low-security, medium-security, or high-security categories based on predefined features such as transaction amount, location, and user behavior. Unsupervised learning, including clustering algorithms like K-means and DBSCAN, can be used to detect anomalies in transaction patterns, identifying suspicious activity that deviates from normal behavior. Reinforcement learning can optimize encryption selection by continuously learning which cryptographic approach provides the best security performance under different transaction scenarios. Examples of machine learning models applicable to the invention include Random Forest for fraud detection, Support Vector Machines (SVM) for classification, and XGBoost for risk assessment.

Deep Learning (DL) is a subset of machine learning that uses artificial neural networks with multiple layers to process complex data. Deep learning techniques apply to the invention in areas such as anomaly detection, risk analysis, and transaction authentication. Recurrent Neural Networks (RNNs) and Long Short-Term Memory (LSTM) networks are useful for analyzing sequential transaction data, finding recurring patterns, and detecting irregularities in user behavior. Transformer-based deep learning models, such as BERT and GPT, can be used to analyze unstructured financial transaction data, identifying risk factors that may not be apparent through traditional machine learning approaches. Convolutional Neural Networks (CNNs) can be adapted for cybersecurity applications, detecting adversarial attacks that try to compromise transaction authentication systems. Deep learning can also enhance biometric authentication in secure financial transactions by analyzing facial recognition data, fingerprint scans, and voice authentication patterns.

Natural Language Processing (NLP) is a field of artificial intelligence that focuses on the interaction between computers and human language. NLP applies to the invention in user authentication, identity verification, and fraud detection. The system can use NLP to analyze text-based transaction instructions, verify secure messages, and detect phishing attempts or fraudulent communication. Sentiment analysis can identify potentially suspicious transaction requests based on linguistic patterns that indicate coercion or fraud. Named Entity Recognition (NER) models can extract meaningful transaction details from financial statements, improving security tracking. Examples of NLP models that can be integrated include OpenAI's GPT models for analyzing user queries and IBM Watson for automated identity verification through natural language interactions.

Expert Systems are AI-driven rule-based decision-making systems that use predefined knowledge bases to solve specific problems. Expert systems highly apply to enforcing security policies, selecting encryption levels, and determining access control decisions based on predefined regulatory and business rules. In this invention, an expert system can determine whether a financial transaction should be encrypted using legacy encryption, hybrid encryption, or lattice-based encryption based on predefined policies. It can also enforce access restrictions based on enterprise security protocols, transaction categories, and compliance requirements. Examples of expert system frameworks that can be applied include CLIPS (C Language Integrated Production System) for rule-based decision-making and Drools, an open-source business rules management system.

Fuzzy Logic is a type of artificial intelligence that allows for approximate reasoning rather than strict binary decisions. It is applicable in financial transaction security where uncertainty exists, such as in fraud detection and risk classification. Unlike conventional logic systems that classify transactions as either fraudulent or legitimate, fuzzy logic allows for partial classification based on degrees of suspicion. It can be used to assign different levels of encryption dynamically based on varying risk factors, making sure transactions with higher risk receive stronger encryption. Fuzzy inference systems, such as the Mamdani or Sugeno models, can be used to optimize encryption selection and fraud risk evaluation in the invention.

Generative Adversarial Networks (GANs) have two competing neural networks—a generator and a discriminator—that work together to generate realistic synthetic data. GANs apply to the invention in generating synthetic financial transaction datasets for training fraud detection models, improving anomaly detection, and simulating quantum cryptographic attacks. By generating realistic fraudulent transaction patterns, GANs can help the system refine its ability to detect emerging fraud techniques. GANs can also simulate adversarial attacks on authentication mechanisms to strengthen the security of lattice-based encryption. Examples of GAN architectures applicable to the invention include Deep Convolutional GANs (DCGAN) for generating transaction pattern data and Wasserstein GANs (WGAN) for simulating attack scenarios.

Autonomous Agents and Multi-Agent Systems (MAS) involve AI-driven entities that operate independently or collaboratively to meet specific goals. Autonomous agents can be used in the invention to track security policies, detect unauthorized access attempts, and adjust encryption configurations based on real-time risk assessments. Multi-agent systems can handle different security validation tasks, such as executing quantum attack simulations, reinforcing lattice encryption, and coordinating secure data storage. Integrating multi-agent systems allows for a decentralized approach to security, reducing the risk of single points of failure in financial transaction protection. Examples of AI frameworks that support autonomous agents include JADE (Java Agent Development Framework) for multi-agent communication and OpenAI Gym for reinforcement learning-driven security decision-making.

Quantum Artificial Intelligence (Quantum AI) is an emerging field that applies quantum computing principles to enhance AI models. Quantum AI is highly relevant to this invention, particularly in quantum attack simulations and encryption validation. Quantum AI can be used to simulate potential decryption attacks on lattice-based encryption, identifying vulnerabilities before they can be targeted. Quantum-enhanced machine learning models can improve fraud detection by analyzing vast transaction datasets with significantly higher computational efficiency than classical AI. Quantum Support Vector Machines (QSVM) and Quantum Neural Networks (QNN) are examples of Quantum AI techniques that can enhance financial data security by detecting quantum attack patterns more effectively.

Computer Vision (CV) is an AI field that focuses on enabling computers to interpret visual data. Computer vision applies to implementing biometric authentication for secure financial transactions, including facial recognition, retina scans, and fingerprint verification. These biometric security measures can be integrated with lattice-based cryptography to enhance authentication security for high-risk transactions. AI-driven object detection models, such as YOLO (You Only Look Once) and OpenCV-based facial recognition, can be used to verify user identity before allowing encrypted transactions.

Evolutionary Computation, including genetic algorithms and swarm intelligence, can optimize security configurations by evolving encryption parameters. Evolutionary algorithms can be used to fine-tune lattice-based encryption parameters, ensuring ideal security against potential attacks. They can also optimize homomorphic encryption settings to balance computational efficiency and security strength. Examples of evolutionary AI techniques applicable to this invention include Genetic Algorithms (GA) for encryption parameter optimization and Particle Swarm Optimization (PSO) for adaptive security policy selection.

By integrating these artificial intelligence methodologies, the invention provides an advanced, intelligent, and adaptive security framework for financial transactions. The combination of machine learning, deep learning, natural language processing, expert systems, fuzzy logic, GANs, multi-agent systems, quantum AI, computer vision, and evolutionary computation enables real-time fraud detection, quantum-resistant encryption, automated security validation, and secure access control. These AI-driven enhancements make sure financial transactions remain protected against both conventional cyber threats and emerging quantum computing risks, providing a future-proof security solution for financial institutions.

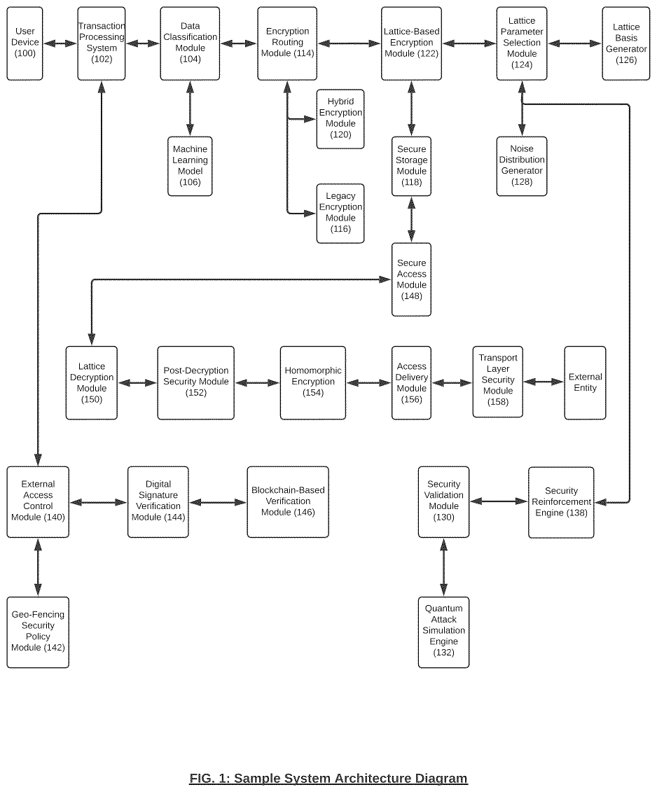

FIG. 1 is a sample system architecture diagram that illustrates a highly advanced framework for securing financial data using lattice-based cryptography, dynamic encryption selection, adaptive security validation, and authenticated access control. This architecture ensures sensitive financial transactions remain protected against both classical and quantum computing threats by integrating multiple layers of encryption, security validation, access authentication, and secure data transmission. The system begins with a user device (100), which represents any computing device used to make financial transactions. This can include mobile phones, desktop computers, automated teller machines (ATMs), banking kiosks, and enterprise financial workstations. A user interacting with this device makes a financial transaction, such as a fund transfer, account balance inquiry, loan request, or credit permission, which is then processed through the transaction processing system (102).

The transaction processing system (102) is responsible for handling financial transactions and generating metadata that describes transaction details. This metadata includes essential information such as the transaction type, amount, originating application, timestamp, user identifier, and other contextual data. The transaction processing system forwards both the financial data and the transaction metadata to the data classification module e (104), which determines the confidentiality classification of the data. The data classification module (104) assesses whether the financial data requires low-security encryption, high-security encryption, or a hybrid approach by analyzing the transaction metadata. This module operates with a machine learning model (106), which enhances classification accuracy by assessing risk levels associated with each transaction.

The machine learning model (106) is trained on historical transaction data, fraud detection patterns, geolocation-based risk assessments, device fingerprinting techniques, and real-time cybersecurity threat intelligence. It continuously adapts its classification criteria based on new data to refine security assessments. For example, if a high-value transaction is initiated from an unusual location or through a device that has not been previously registered to the user, the model may classify the transaction as high risk and recommend applying a stronger encryption method. However, transactions that match historical patterns, such as routine payroll deposits from an employer, may be classified as low risk and encrypted using standard public-key cryptography.

Once the confidentiality classification is determined, the encryption routing module (114) selects the encryption method based on enterprise security policies and the transaction's risk classification. If the financial data is classified as low-security, it is encrypted using the legacy encryption module (116), which applies conventional public-key encryption techniques such as RSA, ECC, or AES before storing the encrypted financial data in the secure storage module (118). These encryption methods provide adequate security for routine financial transactions, such as low-value purchases and account balance inquiries. If the data is classified as medium-security, the hybrid encryption module (120) is engaged, which applies both a public-key encryption algorithm and lattice-based encryption to provide layered security. This ensures that even if one encryption layer is compromised, the financial data remains protected under an additional security mechanism. For high-security data, the lattice-based encryption module (122) is selected, applying lattice-based cryptographic techniques that are resistant to quantum decryption attacks.

Before encryption, the lattice parameter selection module (124) generates dynamic lattice parameters customized for each transaction. These parameters are determined based on multiple security factors, including user identity, transaction type, transaction amount, originating application, and enterprise-defined encryption policies. The lattice basis generator (126) creates the mathematical lattice structure that defines the encryption space, ensuring each transaction receives a unique encryption configuration. For example, a wire transfer between international banks may require a lattice basis with a higher modulus and dimensionality to enhance security. Simultaneously, the noise distribution generator (128) produces a noise function tailored to the specific financial data, increasing encryption randomness to prevent adversaries from breaking the encryption using pattern analysis. The level of noise introduced is adjusted dynamically to ensure each encrypted transaction maintains an ideal balance between security and computational efficiency.

Once the lattice parameters are generated, the lattice-based encryption module (122) encrypts the financial data by transforming it into a lattice vector representation and applying the lattice basis and noise function. The encrypted financial data is then stored in the secure storage module (118), ensuring it remains protected from unauthorized access. To ensure encryption robustness, the security validation module (130) continuously evaluates the strength of encrypted financial records. This module uses the quantum attack simulation engine (132), which runs simulated quantum decryption attempts, including well-known quantum algorithms such as Shor's and Grover's, to test whether the encryption can be compromised. If a vulnerability is detected, the security reinforcement engine (138) dynamically increases lattice complexity by adjusting the lattice basis, increasing modulus size, or changing noise distribution parameters to fortify encryption security against potential quantum decryption attempts.

The secure storage module (118) serves as the primary repository for encrypted financial data and enforces strict access control policies to prevent unauthorized decryption. The system employs an external access control module (140) to regulate decryption requests and enforce enterprise-level security policies before access is granted.

When an external entity, such as a regulatory agency or financial service provider, requests access to encrypted financial data, the request is processed by the external access control module (140). This module verifies that the external request complies with enterprise access policies before granting decryption privileges. The system enforces geo-fencing security policies (142), which analyze the geographical origin of the request and compare it against preconfigured enterprise security rules. If a decryption request originates from an unauthorized geographic location, access is automatically denied. For example, a bank may configure its system to restrict decryption requests from countries that do not meet its regulatory compliance requirements.

For authentication, the system employs the digital signature verification module (144), which ensures that only authorized external entities can access encrypted financial data. This module uses a blockchain-based verification module (146) to store and validate authentication signatures on an immutable blockchain ledger, preventing unauthorized modifications or signature forgeries. If an external entity successfully authenticates, the secure access module (148) retrieves the encrypted financial data from the secure storage module (118) and forwards it to the lattice decryption module (150).

The lattice decryption module (150) reconstructs the original financial data by applying an inverse lattice transformation to convert the encrypted lattice structure back into a readable format. It then removes the noise distribution function and retrieves the original financial data, ensuring that only authorized users have access to decrypted records. Before transmission to the requesting entity, the post-decryption security module (152) encrypts the financial data using a homomorphic encryption scheme, allowing computations to be performed on the encrypted data while preserving confidentiality. For example, a financial auditing firm may need to process encrypted transaction data for compliance reporting without accessing the raw financial details.

The Homomorphic Encryption (154) module enables computations to be performed on encrypted financial data without needing to decrypt it first. This ensures that sensitive data remains confidential while still allowing operations such as fraud detection, risk analysis, and compliance reporting to be executed securely. For example, a financial auditing firm could analyze transaction patterns without exposing raw financial details, maintaining both privacy and security.

The Access Delivery Module (156) is responsible for securely managing and transmitting financial data after decryption or encryption updates. It ensures that only authorized recipients receive the processed data by enforcing security protocols such as role-based access control and multi-factor authentication. This module applies additional security layers to prevent data leaks, unauthorized modifications, or interception during transmission.

The Transport Layer Security Module (158) applies cryptographic encryption to secure financial data during transmission over external or internal networks. It prevents unauthorized interception, tampering, or replay attacks by implementing industry-standard security protocols such as TLS 1.3. For example, when encrypted financial reports are transmitted between banking institutions, this module ensures that all communications remain encrypted and secure from cyber threats.

To maintain end-to-end security, the access delivery module (156) applies additional security measures before transmitting financial records externally. The module utilizes a transport layer security module (158) to encrypt network communications, preventing unauthorized interception of financial data in transit. This final layer of security ensures that even after decryption, financial records remain protected against cyber threats during transmission.

The entire system architecture ensures that financial institutions can secure sensitive transaction records while maintaining compliance with regulatory standards such as PCI-DSS, GDPR, and post-quantum cryptographic requirements. The system dynamically adapts to security threats by modifying encryption configurations in response to real-time risk assessments, ensuring that financial data remains protected against both conventional cyber threats and future quantum computing decryption capabilities. By integrating lattice-based encryption, real-time anomaly detection, quantum security validation, blockchain-based authentication, and distributed secure storage, this system provides a comprehensive framework for securing financial transactions across multiple digital banking environments.

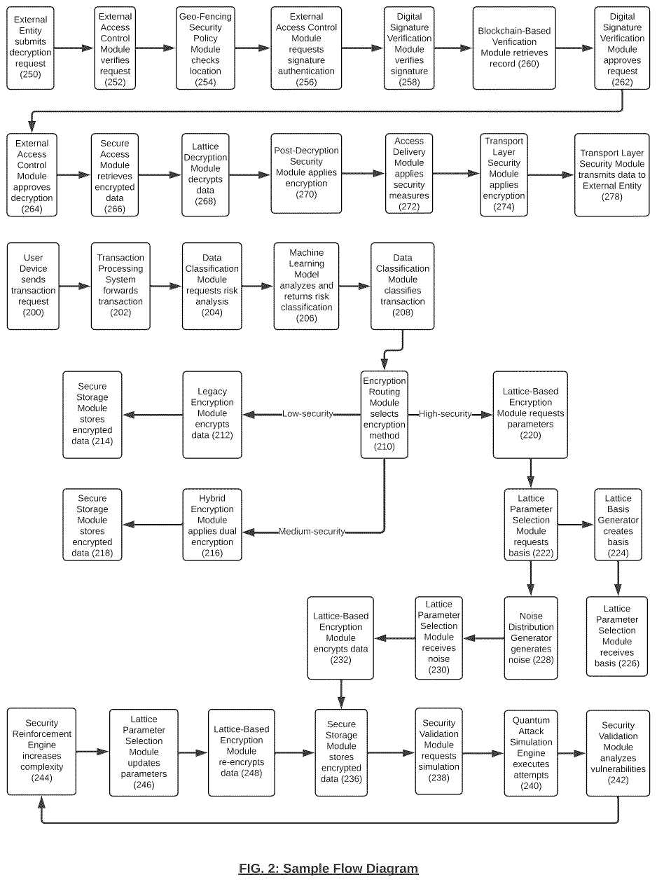

FIG. 2 is a flow diagram that provides a detailed and structured representation of how financial transaction data is processed, encrypted, validated, stored, decrypted, and securely transmitted using dynamic encryption selection, lattice-based cryptography, quantum-resistant security validation, and authenticated access control. The process begins when a user device sends a transaction request (200), containing metadata and financial data, to the transaction processing system (202). The transaction metadata includes essential details such as the transaction type, transaction amount, user identifier, timestamp, originating application, device information, and geographic location. The transaction processing system (202) forwards the transaction details to the data classification module (204) for risk assessment.

Upon receiving the transaction metadata, the data classification module (204) requests a risk analysis from the machine learning model (206) to determine whether the transaction poses a potential risk. The machine learning model (206) evaluates the transaction using historical fraud patterns, user behavioral trends, and real-time cybersecurity threat intelligence. Based on its assessment, it returns a risk classification (208), categorizing the transaction as low-security, medium-security, or high-security. The data classification module (208) then assigns the appropriate classification level and transmits the classification decision to the encryption routing module (210).

The encryption routing module (210) determines the encryption method based on the transaction's classification. If the transaction is low-security, it is sent to the legacy encryption module (212), which applies traditional encryption methods such as RSA, ECC, or AES. If the transaction is medium-security, it is sent to the hybrid encryption module (216), which applies a combination of public-key encryption and lattice-based encryption for added protection. If the transaction is high-security, it is directed to the lattice-based encryption module (220) for quantum-resistant encryption.

The lattice-based encryption module (220) first requests encryption parameters from the lattice parameter selection module (222). The lattice parameter selection module (222) then requests a lattice basis from the lattice basis generator (224) and a noise distribution function from the noise distribution generator (228) to configure the encryption model. Once the encryption parameters, lattice basis, and noise function are received, the lattice parameter selection module (230) compiles the final encryption settings and sends them to the lattice-based encryption module (232).

The lattice-based encryption module (232) encrypts the financial transaction data and transmits the encrypted data to the secure storage module (236). The secure storage module (236) ensures that the encrypted records are protected by strict access controls and are stored securely.

To validate the strength of the encryption, the security validation module (238) initiates a quantum attack simulation using the quantum attack simulation engine (240). The quantum attack simulation engine (240) attempts to break the encryption using quantum algorithms such as Shor's algorithm and Grover's search algorithm. The security validation module (242) then analyzes the results to determine if vulnerabilities exist.

If vulnerabilities are detected, the security reinforcement engine (244) adjusts encryption parameters to strengthen security. The updated parameters are sent back to the lattice parameter selection module (246), which regenerates stronger encryption settings and provides them to the lattice-based encryption module (248). The lattice-based encryption module (248) then re-encrypts the financial data and transmits it back to the secure storage module (236).

When an external entity submits a decryption request (250), the request is verified by the external access control module (252), which enforces security policies. The geo-fencing security policy module (254) checks the geographic origin of the request to determine whether access should be granted.

If the request passes the geo-fencing verification, the external access control module (256) proceeds with authentication by requesting digital signature verification (258). The digital signature verification module (258) authenticates the request and forwards it to the blockchain-based verification module (260), which retrieves authentication records from an immutable blockchain ledger. If authentication is successful, the digital signature verification module (262) approves the request.

The external access control module (264) grants decryption approval, and the secure access module (266) retrieves the encrypted data from the secure storage module (236). The lattice decryption module (268) decrypts the transaction data by reversing the lattice encryption process, applying an inverse transformation to reconstruct the original financial data.

The post-decryption security module (270) applies additional security checks before the decrypted financial data is transmitted. The access delivery module (272) ensures compliance with enterprise security policies, applying security measures such as access controls and authentication verification.

The transport layer security module (274) encrypts the network transmission to prevent unauthorized interception. Finally, the transport layer security module (278) securely transmits the encrypted financial transaction data to the external entity, ensuring data integrity and confidentiality throughout the transmission process.

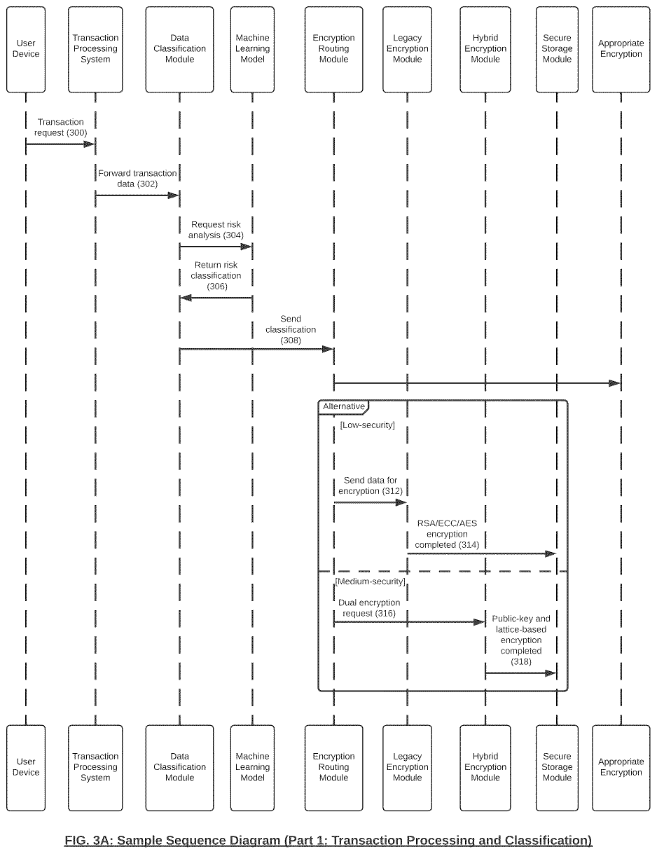

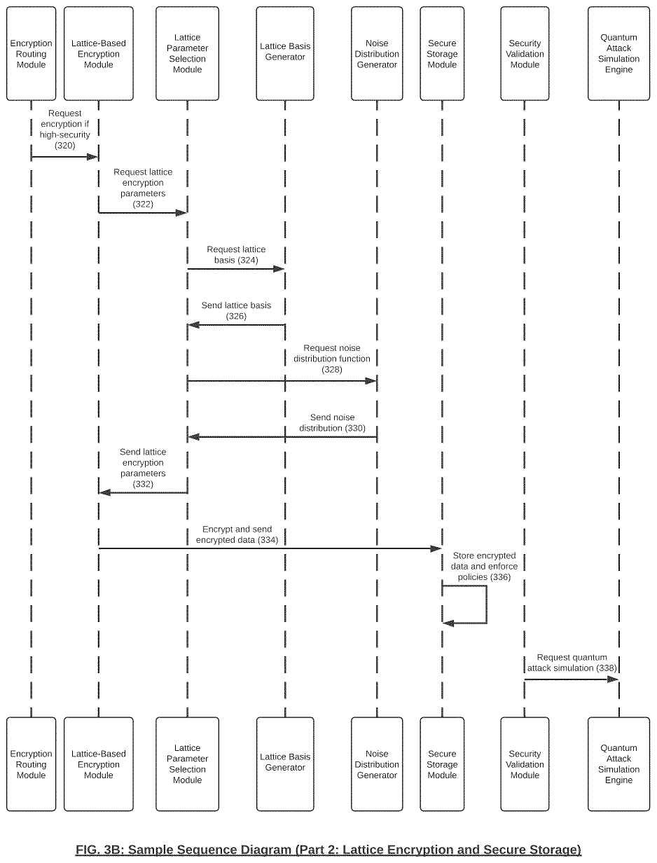

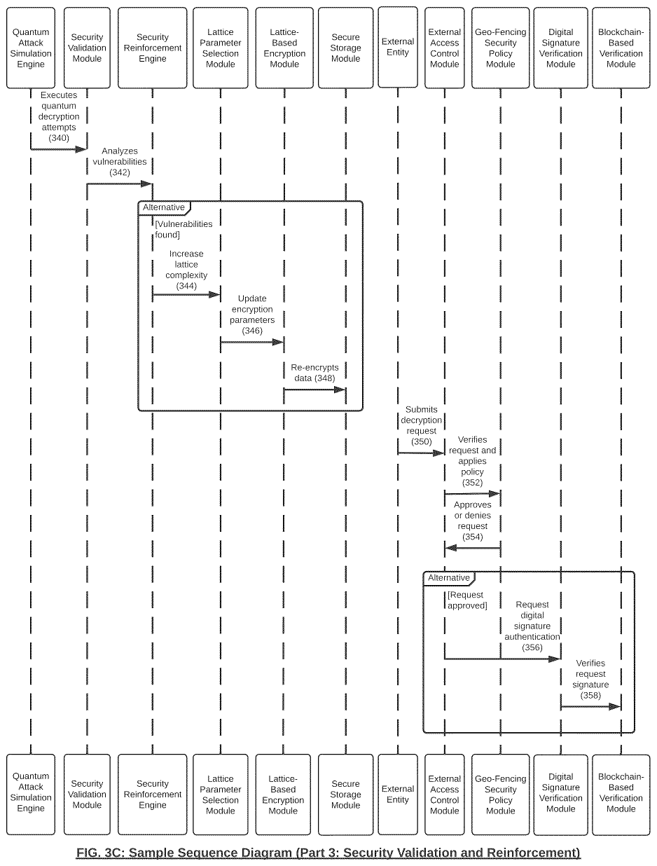

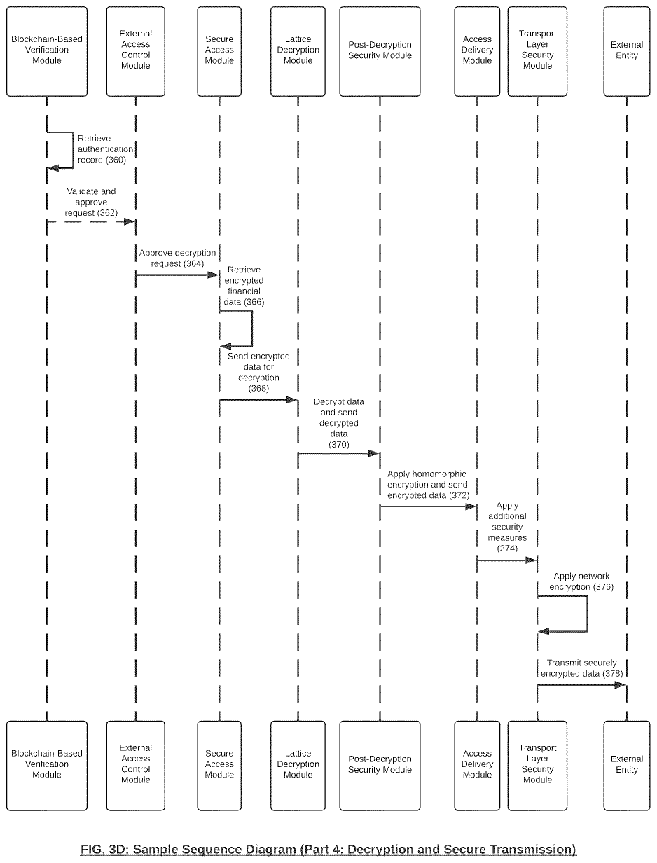

FIGS. 3A-3D collectively illustrate an exemplary sequence diagram showing the detailed interactions between various system components that work together to secure financial transactions through classification, encryption, validation, storage, decryption, and secure transmission.

FIG. 3A, Transaction Processing and Classification, focuses on how a financial transaction request is initiated, processed, classified for security risk, and routed to the appropriate encryption module. The user device submits a transaction request, which is analyzed by the transaction processing system. The data classification module evaluates the security level of the transaction using a machine learning model, determining whether it is low-security, medium-security, or high-security. Based on this classification, the encryption routing module selects an appropriate encryption method and forwards the data to the corresponding encryption module.

FIG. 3B, Lattice Encryption and Secure Storage, covers the encryption process for high-security transactions using lattice-based cryptography. The encryption routing module directs the transaction data to the lattice-based encryption module, which requests encryption parameters from the lattice parameter selection module. The lattice basis generator and noise distribution generator provide additional cryptographic elements to enhance security. Once encryption is completed, the encrypted data is stored securely in the secure storage module, where strict access control policies are enforced.

FIG. 3C, Security Validation and Reinforcement, focuses on the validation of encryption security and reinforcement measures. The security validation module initiates quantum attack simulations using a quantum attack simulation engine that applies decryption attempts using Shor's and Grover's algorithms. If vulnerabilities are detected, the security reinforcement engine updates encryption parameters and increases lattice complexity. The updated encryption parameters are then sent back to the lattice-based encryption module, which re-encrypts the financial data before storing it securely.

FIG. 3D, Decryption and Secure Transmission, details how an external entity requests access to encrypted financial data and the security measures applied before decryption and transmission. The external access control module verifies the request using geo-fencing policies and digital signature authentication. The blockchain-based verification module retrieves authentication logs to confirm request legitimacy. If authentication is successful, the secure access module retrieves encrypted data, which is decrypted using the lattice decryption module. The post-decryption security module applies homomorphic encryption to protect data before transmission. The access delivery module ensures compliance with security policies before sending the data through the transport layer security module, which encrypts the transmission before delivering the financial data to the authorized external entity.

More specifically, the sequence of events begins with a user initiating a financial transaction from a user device. The user device could be a mobile phone, computer, banking terminal, or another electronic interface capable of generating a secure financial request. The transaction request consists of multiple parameters, including transaction metadata such as the transaction type, transaction amount, user identification, timestamp, geographic location, and the originating application. The user device sends this transaction request, along with the associated metadata and financial data, to the transaction processing system, which serves as the entry point for handling transactions within the secure architecture (300).

Upon receiving the transaction request, the transaction processing system performs initial validation checks, ensuring that the transaction request is properly formatted and includes all required metadata. The system extracts relevant transaction details and forwards them to the data classification module for security assessment (302). The data classification module is responsible for determining the level of security required for the transaction before it can proceed further. This classification is crucial, as it dictates the encryption method that will be used to secure the transaction data. To determine the appropriate classification, the data classification module sends a request to the machine learning model, which is trained to analyze transaction metadata, user behavior, and external cybersecurity threat intelligence (304).

The machine learning model receives the request and processes the transaction data through a series of analytical models. It evaluates the risk level of the transaction based on multiple factors, including historical transaction patterns, known fraud indicators, geographic anomalies, device authentication logs, spending behavior, and security policies configured by the enterprise. The machine learning model applies supervised learning techniques to classify transactions that match previously identified fraud patterns, unsupervised anomaly detection to identify new and unknown patterns of fraudulent activity, and reinforcement learning to optimize its classification capabilities over time. Once the analysis is completed, the machine learning model generates a risk classification score and assigns the transaction to a predefined security category. It then sends the classification results back to the data classification module, indicating whether the transaction is low-security, medium-security, or high-security (306).

The data classification module receives the classification result and determines the appropriate security measures that must be applied to the transaction. Transactions classified as low-security typically involve routine activities such as small fund transfers, account balance inquiries, or automated recurring payments. Medium-security transactions involve moderate risks, such as vendor payments or wire transfers within trusted banking networks. High-security transactions involve significant financial transfers, regulatory-sensitive transactions, or cases where multiple risk indicators have been triggered, such as an unusual device or location used for the transaction. Based on this classification, the data classification module forwards the classification result to the encryption routing module, which determines the appropriate encryption method to apply for securing the transaction (308).

The encryption routing module is responsible for dynamically selecting the most suitable encryption mechanism based on the security classification assigned to the transaction. If the transaction is categorized as low-security, the encryption routing module determines that standard encryption is sufficient and directs the transaction data to the legacy encryption module (310). The legacy encryption module applies conventional cryptographic techniques such as RSA, ECC, or AES, ensuring that the transaction data is encrypted using well-established security protocols that provide sufficient protection for lower-risk transactions. Once the encryption process is complete, the legacy encryption module transmits the encrypted transaction data to the secure storage module, where it is stored with enforced access controls to prevent unauthorized retrieval (312). Step 314 refers to the completion of RSA/ECC/AES encryption in the Legacy Encryption Module. This step confirms that financial transaction data classified as low-security has been successfully encrypted using traditional encryption techniques before being stored or transmitted within the system.

If the transaction is classified as medium-security, the encryption routing module determines that additional security layers are required. In this case, the encryption routing module forwards the transaction data to the hybrid encryption module (316). The hybrid encryption module enhances security by applying both public-key encryption and lattice-based encryption, creating a dual-layer encryption approach that provides redundancy and increased resistance against decryption attacks. This hybrid approach ensures that even if one encryption method is compromised, the additional encryption layer remains intact, preventing unauthorized access. Once the hybrid encryption is applied, the encrypted data is securely transmitted to the secure storage module, where it is protected under enterprise-defined security policies and access control mechanisms (318).

If the transaction is classified as high-security, the encryption routing module determines that the most advanced quantum-resistant encryption must be applied to secure the transaction. Instead of using legacy or hybrid encryption methods, the transaction is sent to the lattice-based encryption module, which is specifically designed to provide maximum security against both classical and quantum decryption attacks. The encryption routing module forwards the transaction data to the lattice-based encryption module to initiate the encryption process (320).

This sequence of events in this portion of the sequence diagram ensures that financial transactions are classified according to their risk level before encryption is applied. The use of a machine learning model for risk assessment enhances the accuracy of classification by continuously learning from new transaction patterns and emerging cybersecurity threats. The encryption routing module dynamically selects the appropriate encryption strategy, ensuring that each transaction is encrypted in accordance with its security classification. By implementing multiple encryption methodologies, including legacy encryption, hybrid encryption, and lattice-based encryption, the system maintains a flexible security framework capable of handling transactions of varying risk levels while preventing unauthorized access and ensuring compliance with financial security regulations.

Once the encryption routing module has determined that a transaction falls into the high-security classification, it forwards the transaction request to the lattice-based encryption module, which is responsible for applying quantum-resistant encryption techniques to the financial data (320). The lattice-based encryption module is specifically designed to handle high-risk financial transactions, ensuring that the encryption applied is resistant to both classical and quantum computing-based decryption attacks. Before the encryption process can proceed, the lattice-based encryption module must obtain encryption parameters that are dynamically generated for each transaction. To accomplish this, the lattice-based encryption module sends a request to the lattice parameter selection module, which is responsible for generating and selecting encryption parameters based on multiple transaction attributes, enterprise security rules, and cryptographic strength requirements (322).

Upon receiving the request, the lattice parameter selection module begins the process of generating a secure encryption framework. To do this, it first requests a lattice basis from the lattice basis generator, a specialized component responsible for constructing the fundamental mathematical lattice structure required for encryption (324). The lattice basis generator creates a lattice structure that serves as the core cryptographic foundation for securing the transaction data. This basis consists of a set of linearly independent vectors that define a secure lattice space, ensuring that any encrypted data mapped onto this space remains resistant to decryption, even with advanced computational techniques. The lattice basis generator transmits the generated lattice basis back to the lattice parameter selection module for further processing (326).

Once the lattice basis has been received, the lattice parameter selection module continues the encryption parameter generation process by introducing additional cryptographic randomness. To achieve this, it requests a noise distribution function from the noise distribution generator, a component that is responsible for creating a randomized noise function that strengthens encryption security (328). The noise distribution function introduces intentional randomness into the encrypted data, making it highly resistant to known attack vectors, including lattice reduction techniques and pattern-based decryption methods. The noise distribution generator creates a noise distribution that meets the security criteria specified by the encryption framework and transmits it back to the lattice parameter selection module (330).

With both the lattice basis and noise function now available, the lattice parameter selection module compiles the encryption parameters required for securing the financial transaction. These parameters are customized for the specific transaction, ensuring that each encrypted transaction has a unique cryptographic structure that cannot be easily replicated or predicted. The dynamically generated encryption parameters are then sent to the lattice-based encryption module, providing it with the necessary components to proceed with the encryption process (332).

The lattice-based encryption module applies lattice encryption to the financial data using the provided encryption parameters. During this process, the transaction data is transformed into an encrypted lattice structure that is nearly impossible to break, even with the use of quantum decryption algorithms. The encryption method relies on the hardness of mathematical problems such as the shortest vector problem (SVP) and the learning with errors (LWE) problem, which are computationally infeasible to solve efficiently with both classical and quantum computing resources. Once the encryption process is complete, the lattice-based encryption module transmits the fully encrypted transaction data to the secure storage module, where it will be stored with strict access control policies in place (334).

Upon receiving the encrypted financial data, the secure storage module ensures that it is stored in a highly protected repository, preventing unauthorized access, modification, or retrieval. The secure storage module enforces enterprise security policies, allowing only authorized system components to access or retrieve encrypted data based on predefined rules and cryptographic access control lists (336). To further validate the strength of the encryption, the security validation module initiates a security verification process by requesting a quantum attack simulation from the quantum attack simulation engine (338). This validation step ensures that the encryption applied to the financial transaction remains resilient against emerging threats, including quantum computing-based attacks.

This sequence of events ensures that high-security financial transactions are protected using dynamically generated lattice encryption, with encryption parameters that are unique to each transaction. By incorporating the lattice basis generator and noise distribution generator, the system introduces additional cryptographic security layers, making the encryption highly resistant to both traditional and quantum decryption techniques. The secure storage module ensures that encrypted data remains protected and cannot be accessed without the appropriate cryptographic keys and access controls. The security validation module further enhances protection by proactively testing encryption strength against simulated quantum decryption attempts, ensuring that financial transactions remain secure against evolving cybersecurity threats.

The security validation module, after requesting a quantum attack simulation, ensures that the encryption applied to the financial transaction undergoes rigorous security testing to verify its resilience against quantum-based decryption attempts. The quantum attack simulation engine is responsible for executing simulated quantum-based decryption techniques to assess whether the encryption methods used can withstand advanced cryptographic attacks. The quantum attack simulation engine initiates the attack simulation by employing quantum algorithms such as Shor's algorithm and Grover's algorithm, both of which are designed to efficiently break certain types of encryption when executed on a quantum computing system. Once the quantum decryption attempts are performed, the quantum attack simulation engine compiles the results and transmits them back to the security validation module for further analysis (340).

Upon receiving the quantum attack simulation results, the security validation module performs an in-depth analysis to determine whether any vulnerabilities were detected during the quantum-based decryption attempts. The security validation module evaluates whether the encryption withstood the simulated quantum attacks or if weaknesses in the encryption parameters allowed partial or full decryption of the financial transaction data. If any security weaknesses are identified, the security validation module compiles a report on the vulnerabilities found and transmits this information to the security reinforcement engine, which is responsible for dynamically updating encryption parameters to strengthen the system against future quantum decryption attempts (342).

The security reinforcement engine, upon receiving the security vulnerability report from the security validation module, initiates a corrective action process to enhance encryption resilience. This engine dynamically increases the complexity of the lattice encryption applied to the financial transaction data by modifying encryption parameters such as key size, basis complexity, and noise distribution values. These updates are intended to reinforce encryption strength against increasingly sophisticated quantum decryption attempts. Once the security reinforcement engine generates the updated encryption parameters, it sends them to the lattice parameter selection module, ensuring that all necessary security enhancements are applied to future encryption processes (344).

The lattice parameter selection module, after receiving the enhanced encryption parameters from the security reinforcement engine, updates the cryptographic configurations for lattice-based encryption. These updated parameters modify the encryption structure to increase resistance against attack vectors identified during the quantum attack simulation. The lattice parameter selection module then compiles the updated encryption settings and sends them to the lattice-based encryption module so that it can apply the newly reinforced encryption approach to the financial transaction data (346).

The lattice-based encryption module receives the updated encryption parameters and initiates a re-encryption process to strengthen the security of the already encrypted financial data. This process involves re-encrypting the transaction data using the newly optimized lattice encryption parameters, effectively enhancing security while maintaining compatibility with the existing secure storage and access control mechanisms. The re-encryption process ensures that even if new attack methodologies are developed, the financial data remains resilient against unauthorized decryption attempts. After re-encrypting the financial data, the lattice-based encryption module transmits the updated encrypted data back to the secure storage module, ensuring that the newly reinforced encryption scheme is applied to the stored transaction records (348).

While encryption security is continuously updated, external entities such as financial institutions, regulatory bodies, or third-party service providers may submit decryption requests to access financial transaction data for auditing, compliance, or transaction verification purposes. When an external entity submits a decryption request, it is first received by the external access control module, which is responsible for enforcing enterprise security policies regarding data access and retrieval (350). The external access control module verifies whether the request complies with security policies by enforcing strict authentication and authorization checks before granting access to the encrypted data.

One of the critical security measures applied by the external access control module is geo-fencing, a technique that restricts data access based on predefined geographic security policies. The external access control module applies a geo-fencing security policy by checking the origin of the decryption request against authorized locations configured in the system's security policies. This ensures that financial transaction data can only be accessed from approved geographic regions, reducing the risk of unauthorized access from external threats or cybercriminals operating outside of approved locations. The external access control module submits the request to the geo-fencing security policy module, which evaluates the geographic parameters associated with the request and determines whether access should be granted or denied based on enterprise-defined security restrictions (352).

The geo-fencing security policy module analyzes the decryption request, verifying whether the request originates from a location that has been authorized to access encrypted financial transaction data. If the request originates from a permitted geographic region, the geo-fencing security policy module approves the request and transmits the approval status to the external access control module. If the request originates from an unauthorized location, the request is denied, and access to the encrypted financial transaction data is blocked to prevent potential security breaches. The geo-fencing security policy module finalizes its analysis and transmits the approval or denial response back to the external access control module (354).

If the geo-fencing security policy module approves the request, the external access control module proceeds with additional security verifications before granting access to the requested data. One of the key authentication mechanisms required for access is digital signature verification, ensuring that the request originates from a legitimate, authorized entity. The external access control module submits a request for digital signature authentication to the digital signature verification module, which is responsible for validating the authenticity of cryptographic signatures associated with the decryption request (356).

The digital signature verification module receives the authentication request and verifies the cryptographic signature attached to the decryption request to confirm whether it is valid. Digital signatures ensure that external entities attempting to access encrypted financial data are authenticated using cryptographic keys assigned to their authorized accounts. To strengthen authentication, the digital signature verification module cross-references the request signature with blockchain-based authentication records stored in the system. It submits an authentication request to the blockchain-based verification module to retrieve historical authentication records associated with the requestor's identity (358).

The sequence of interactions ensures that the encryption applied to financial transactions remains resistant to unauthorized decryption attempts while allowing authorized external entities to request access securely. By performing quantum attack simulations, dynamically reinforcing encryption security, enforcing geo-fencing policies, and requiring digital signature verification, the system prevents unauthorized access while ensuring compliance with enterprise security policies. The integration of blockchain-based authentication further enhances security by providing a tamper-proof verification mechanism, ensuring that only authenticated entities can retrieve encrypted financial data.

The blockchain-based verification module is responsible for retrieving authentication records stored in a distributed and tamper-resistant blockchain ledger. Upon receiving a request from the digital signature verification module, the blockchain-based verification module searches for the corresponding authentication record that matches the cryptographic signature associated with the decryption request. Blockchain authentication ensures that historical records of access requests and authorization events are immutable, allowing the system to verify whether the requestor has been previously authenticated and whether the access request aligns with predefined security policies. The blockchain-based verification module retrieves the relevant authentication record and transmits the verification result back to the digital signature verification module, confirming whether the requestor's digital signature is valid and has been successfully authenticated through blockchain records (360).

Once the blockchain-based verification module provides the authentication confirmation, the digital signature verification module finalizes its verification process and transmits an approval status back to the external access control module. If the digital signature verification module confirms that the requestor's identity and digital credentials are legitimate, the external access control module proceeds with granting access to the encrypted financial transaction data. If any inconsistencies, unauthorized modifications, or cryptographic mismatches are detected in the requestor's authentication records, the access request is denied, and the system prevents further processing of the decryption request. If authentication is successful, the digital signature verification module transmits the authentication approval response to the external access control module (362).

Upon receiving the authentication approval from the digital signature verification module, the external access control module determines that the decryption request meets all security policies and authorization requirements. With approval confirmed, the external access control module grants permission for the requested decryption process and transmits a decryption request to the secure access module. The secure access module is responsible for managing decryption operations and ensuring that only authenticated, authorized, and properly verified requests are processed. The secure access module receives the decryption request and initiates the process of retrieving the encrypted financial data from the secure storage module, which holds all encrypted transaction data under strict access control policies (364).

The secure access module submits a request to the secure storage module, instructing it to locate and retrieve the encrypted financial transaction data that corresponds to the requestor's authorized transaction record. The secure storage module enforces access control mechanisms that prevent unauthorized entities from retrieving encrypted transaction data. It verifies that the secure access module is authorized to access the requested data and then retrieves the encrypted transaction record from storage before transmitting it back to the secure access module for further processing (366).

Once the secure access module successfully retrieves the encrypted financial data, it forwards the encrypted data to the lattice decryption module. The lattice decryption module is responsible for performing decryption operations using an inverse lattice transformation, which allows encrypted transaction data to be converted back into its original readable format. The lattice decryption module applies cryptographic key parameters, inverse noise functions, and lattice structure transformations to decrypt the transaction data while maintaining its confidentiality and security integrity. The decryption process ensures that only authorized requestors are able to access transaction data, preventing unauthorized decryption attempts or exposure of sensitive financial information. After successfully decrypting the transaction data, the lattice decryption module transmits the decrypted transaction data to the post-decryption security module for additional security enhancements (368).

The post-decryption security module is responsible for applying additional security measures to protect the integrity of the decrypted transaction data before it is transmitted to the requestor. One of the key security techniques used by the post-decryption security module is homomorphic encryption, which allows computations to be performed on encrypted data without exposing raw financial details. This ensures that even after decryption, transaction data remains protected against unauthorized modifications or malicious attempts to alter financial records. The post-decryption security module applies homomorphic encryption to the decrypted financial data, preserving its confidentiality while allowing for secure processing. Once homomorphic encryption has been applied, the post-decryption security module transmits the encrypted financial data to the access delivery module, which is responsible for ensuring that the data is properly handled before transmission (370).

The access delivery module is responsible for implementing compliance policies and additional security protocols before the financial transaction data is transmitted to the requestor. This module ensures that the decrypted transaction data meets enterprise security regulations, access control restrictions, and data transmission policies. It applies security monitoring techniques to detect potential data manipulation attempts or unauthorized access risks before authorizing data transmission. If the decrypted financial data passes all compliance checks, the access delivery module transmits the encrypted data to the transport layer security module, which is responsible for securing data during network transmission (372).

The transport layer security module ensures that decrypted transaction data remains protected while being transmitted across external networks. This module applies network encryption using advanced TLS protocols to prevent data interception, man-in-the-middle attacks, or unauthorized access during transmission. It secures financial transaction data by encrypting the data packet, ensuring that only the intended requestor with authorized decryption capabilities can access the transmitted financial data. The transport layer security module applies encryption to the transmission channel, ensuring end-to-end data security and preventing unauthorized interception of sensitive transaction records. Once encryption is applied, the transport layer security module transmits the securely encrypted financial data to the external entity that submitted the original decryption request (374).

The external entity, which may be a financial institution, regulatory agency, or third-party service provider, receives the securely transmitted financial transaction data through the encrypted communication channel. The external entity is responsible for using its authorized decryption keys to access the transaction data while maintaining compliance with security and regulatory policies. By ensuring that all security layers—including lattice encryption, post-decryption security, and network transport encryption—are enforced throughout the transaction lifecycle, the system guarantees that financial data remains protected against unauthorized access, fraud, and cybersecurity threats. The completion of the secure data transmission process ensures that financial transaction data is securely accessed only by authenticated and authorized entities, closing the sequence of secure financial transaction handling (376).

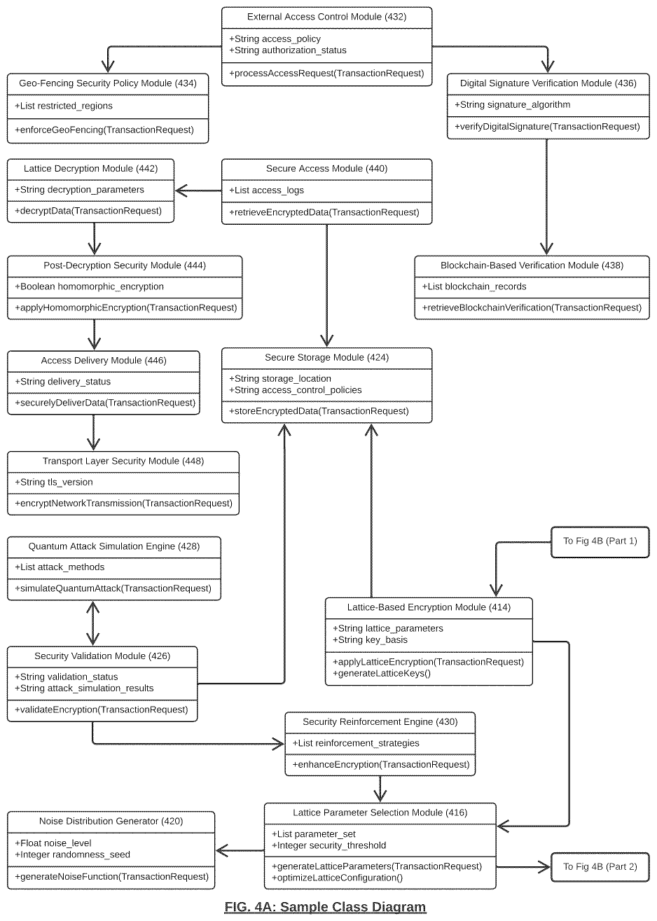

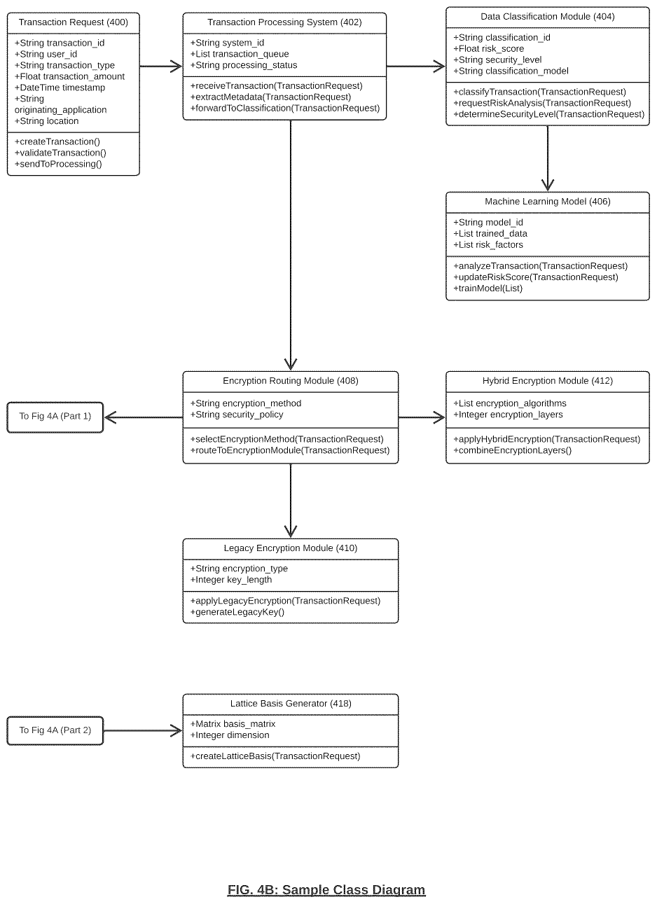

In FIGS. 4A and 4B, the class diagrams represent a highly detailed system architecture designed to secure financial transactions using lattice-based cryptography, dynamic encryption selection, adaptive security validation, and authenticated access control. The system consists of multiple interconnected classes, each responsible for specific functionalities required to process, encrypt, validate, store, decrypt, and securely transmit financial transaction data. Each class contains attributes that define its state and methods that determine its behavior, ensuring a modular and efficient implementation that provides a comprehensive security framework.

The transaction request class, identified as transaction request (400), represents the initial financial transaction request that enters the system. This class contains several attributes, including transaction ID, user ID, transaction type, transaction amount, timestamp, originating application, and location. These attributes define the essential metadata required for classifying and securing a financial transaction. The transaction request class includes methods for creating a new transaction, validating the transaction data, and sending the request to the processing system. Once a transaction is created, it is received by the transaction processing system class, identified as transaction processing system (402), which manages the queue of incoming transactions. This class contains attributes such as system ID, transaction queue, and processing status. The methods available in this class allow it to receive new transaction requests, extract relevant metadata from each transaction, and forward the request to the classification module for further analysis.

The data classification module class, identified as data classification module (404), is responsible for assessing the risk and security level associated with a transaction. This class includes attributes such as classification ID, risk score, security level, and classification model. The classification module utilizes methods that allow it to classify a transaction based on its metadata, request risk analysis from the machine learning model, and determine the appropriate security level for each transaction. To enhance its risk assessment capabilities, the classification module interacts with the machine learning model class, identified as machine learning model (406). The machine learning model contains attributes such as model ID, trained data, and risk factors, enabling it to analyze financial transactions, update risk scores dynamically, and refine its predictive capabilities by continuously learning from historical transaction data. The methods within this class ensure that the system can detect patterns of fraudulent behavior and classify transactions accordingly.

After the transaction's security level is determined, the classification module forwards the transaction to the encryption routing module class, identified as encryption routing module (408). This class is responsible for selecting the appropriate encryption method based on predefined security policies and classification results. The encryption routing module contains attributes such as encryption method and security policy and includes methods that allow it to decide which encryption module to use. If the transaction is classified as low-security, the routing module directs the transaction to the legacy encryption module class, identified as legacy encryption module (410). This class applies encryption techniques such as RSA, ECC, or AES to secure the transaction. It contains attributes defining the encryption type and key length and provides methods for applying legacy encryption and generating encryption keys. If the transaction is classified as medium-security, the routing module directs the transaction to the hybrid encryption module class, identified as hybrid encryption module (412). This class applies both public-key encryption and lattice-based encryption to create a layered encryption model that ensures security redundancy. It contains attributes such as encryption algorithms and encryption layers and includes methods for applying hybrid encryption and combining multiple encryption techniques.

If a transaction is classified as high-security, it is forwarded to the lattice-based encryption module class, identified as lattice based encryption module (414). This class contains attributes such as lattice parameters and key basis, which define the mathematical structure of the lattice encryption scheme. The methods in this class allow it to apply lattice-based encryption and generate secure lattice keys, ensuring that financial transactions remain quantum-resistant. This class interacts with the lattice parameter selection module class, identified as lattice parameter selection module (416), which dynamically generates encryption parameters specific to each transaction. The lattice parameter selection module contains attributes such as parameter set and security threshold and provides methods that generate encryption parameters and optimize lattice configurations based on real-time security requirements. To further refine the encryption process, this class communicates with the lattice basis generator class, identified as lattice basis generator (418), which constructs the mathematical lattice structure required for encryption. This class includes attributes such as basis matrix and dimension and provides methods for generating lattice bases that are unique for each transaction.

Additionally, the encryption system includes the noise distribution generator class, identified as noise distribution generator (420), which enhances security by generating noise functions that introduce randomness into the encryption process. This class contains attributes such as noise level and randomness seed and includes methods that allow it to create noise functions that make decryption more complex. After the necessary encryption parameters have been established, the financial data is encrypted by the lattice encryption module class, identified as lattice encryption module (422). This class converts the financial data into an encrypted lattice structure and contains attributes such as encrypted data and lattice parameters. The encryption method in this class ensures that sensitive transaction data is protected before it is stored in the secure storage module class, identified as secure storage module (424). This storage module enforces strict access control policies and ensures that encrypted transaction data remains protected against unauthorized access. It contains attributes such as storage location and access control policies and provides methods for storing and managing encrypted financial records.

To maintain encryption robustness, the security validation module class, identified as security validation module (426), initiates quantum attack simulations to evaluate whether the encryption is resistant to quantum decryption attempts. This class contains attributes related to validation status and attack simulation results and includes methods for validating encryption security. It communicates with the quantum attack simulation engine class, identified as quantum attack simulation engine (428), which executes simulated decryption attempts using quantum attack models such as Shor's and Grover's algorithms. If vulnerabilities are detected, the security reinforcement engine class, identified as security reinforcement engine (430), dynamically updates encryption parameters by adjusting lattice complexity, increasing modulus values, or introducing additional security features.

If an external entity submits a request to access encrypted financial data, the request is processed by the external access control module class, identified as external access control module (432). This module ensures that all external access requests comply with predefined security policies. It contains attributes such as access policy and authorization status and includes methods for processing access requests. To further enhance security, the request undergoes a geo-fencing security check by the geo fencing security policy module class, identified as geo fencing security policy module (434), which restricts access based on geographic location. If access is approved, the external request is authenticated using digital signatures through the digital signature verification module class, identified as digital signature verification module (436). This class contains attributes such as signature algorithm and methods for verifying digital signatures.

To prevent unauthorized access, the digital signature verification module communicates with the blockchain based verification module class, identified as blockchain based verification module (438), which retrieves authentication logs from an immutable blockchain ledger. If authentication is successful, the secure access module class, identified as secure access module (440), retrieves encrypted financial data from the secure storage module. The lattice decryption module class, identified as lattice decryption module (442), then applies an inverse lattice transformation to restore the original financial data. The post decryption security module class, identified as post decryption security module (444), applies homomorphic encryption to ensure continued data security even after decryption. The encrypted data is then transmitted through the access delivery module class, identified as access delivery module (446), which prepares the data for final delivery. To protect data during transmission, the transport layer security module class, identified as transport layer security module (448), applies secure network encryption before the financial data is sent to the external entity.

This class diagram ensures a structured, modular, and quantum-resistant security architecture for processing financial transactions. By integrating risk classification, encryption selection, quantum attack simulation, blockchain-based authentication, and homomorphic encryption, the system provides a comprehensive security framework that protects financial transactions from unauthorized access and evolving cyber threats. The interconnected nature of these classes ensures that every stage of the transaction process maintains the highest level of security, providing a robust and adaptable cryptographic solution.

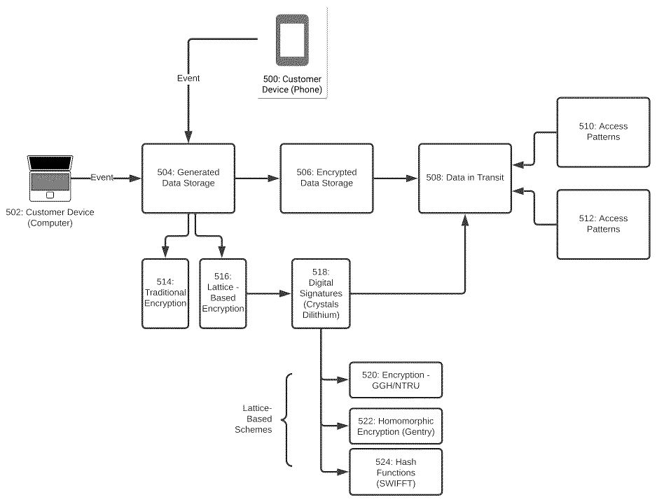

FIG. 5 is a context diagram that illustrates the encryption and security framework used to protect financial transactions and sensitive data through lattice-based cryptography and other advanced cryptographic techniques. The diagram represents the interactions between various system components, including customer devices, encryption mechanisms, data storage, access control policies, authentication protocols, and data transmission security. The architecture ensures that financial data is protected throughout its lifecycle, from generation to storage, processing, transmission, and access, while implementing multiple security measures to prevent unauthorized access, data tampering, and quantum computing-based attacks.

The diagram begins with two primary sources from which financial data is generated, labeled as customer device phone (500) or computer (502). These devices represent endpoints where users initiate financial transactions, submit sensitive information, and interact with the financial system. The customer device (phone) (500) represents mobile-based transactions that may be initiated through mobile banking applications, digital wallets, or payment gateways. The customer device (computer) (502) represents transactions initiated from web-based banking platforms, financial services applications, or enterprise workstations. Both types of customer devices serve as entry points into the financial system, generating transaction data that requires immediate encryption and security protection.

Once financial transaction data is generated on the customer device (500) or customer device (computer) (502), it is initially stored in a repository labeled generated data storage (504). This component serves as the first point of storage for all financial transaction details, including user identity, transaction amount, account details, timestamps, geographic location, and transaction metadata. At this stage, financial transaction data remains in an unencrypted state, making it vulnerable to security risks if not immediately secured. To ensure protection, the system initiates an encryption process that converts the generated data into a secure format before any further processing or storage occurs.

The encrypted data storage (506) component represents the secure repository where financial transaction data is stored after being encrypted using advanced cryptographic techniques. This storage ensures that financial records remain protected from unauthorized access, data breaches, and external cyber threats. By implementing strong encryption methods before storage, the system guarantees that even if encrypted financial data is exposed, it remains inaccessible without the appropriate cryptographic keys and decryption mechanisms. The transition from generated data storage (504) to encrypted data storage (506) is a critical step in the security architecture, as it prevents unauthorized access to sensitive financial records.

To safeguard financial data while it is being transmitted between customer devices (500, 502), storage locations (504, 506), and external systems, the architecture includes a dedicated data in transit (508) component. This element ensures that transaction data remains encrypted while traveling across networks, whether it is being transmitted between customer devices (500, 502) and banking servers, stored on secure cloud-based platforms, or exchanged with external financial institutions. The data in transit (508) component prevents unauthorized interception, eavesdropping, or man-in-the-middle attacks by ensuring that financial data remains encrypted until it reaches its intended destination.

The system enforces strict access control policies through predefined access patterns, represented in the diagram as access patterns (510) and (512). These access patterns define how encrypted financial data can be accessed and under what conditions it can be decrypted. The access patterns (510, 512) component monitors user activity, transaction history, geographic locations, and security clearance levels to determine whether a particular access request is authorized. By analyzing access patterns (510, 512), the system can detect anomalies, prevent unauthorized access attempts, and enforce enterprise security policies. If a user or system attempts to retrieve encrypted financial data in a way that deviates from normal access patterns, the system flags the request for additional verification or denies access altogether.

To protect financial transactions, the system employs multiple encryption methods, beginning with traditional encryption (514) techniques. The traditional encryption (514) component includes widely used cryptographic methods such as RSA, AES, and ECC, which are applied to low-risk financial transactions. While these encryption methods offer strong protection against conventional security threats, they are increasingly vulnerable to decryption attempts using advanced computational power and emerging quantum computing technologies. Therefore, the system integrates an additional layer of encryption through lattice-based encryption (516), which provides quantum-resistant security.

Lattice-based encryption (516) is a cryptographic technique designed to protect sensitive financial data against quantum computing-based decryption attempts. Unlike traditional encryption (514) methods, lattice-based encryption (516) relies on the mathematical complexity of lattice structures, making it infeasible for even the most advanced quantum algorithms to break. The lattice-based encryption (516) component ensures that financial transaction data classified as high-risk remains protected against unauthorized decryption, even in the presence of future quantum computing advancements. This form of encryption is particularly effective in securing sensitive banking transactions, cryptocurrency exchanges, digital asset management, and secure financial communications.

To further enhance security, the system incorporates digital signatures using Crystals Dilithium (518), a post-quantum digital signature algorithm that ensures the integrity and authenticity of financial transactions. The digital signatures (518) component applies cryptographic signatures to financial transaction records, allowing the system to verify that the data has not been tampered with or modified by unauthorized parties. By integrating digital signatures (518), the system ensures that every financial transaction remains traceable and verifiable, providing an additional layer of authentication and fraud prevention.

The encryption framework also includes encryption-GGH/NTRU (520), which represents encryption schemes based on GGH and NTRU cryptographic models. The GGH encryption method, named after Goldreich, Goldwasser, and Halevi, uses lattice-based cryptography to ensure secure key exchange and encryption processes. The NTRU encryption method, known for its efficiency and quantum resistance, provides an additional security layer by using polynomial-based lattice cryptography to encrypt financial transaction data. The encryption-GGH/NTRU (520) component offers a secure foundation for protecting sensitive financial records and preventing unauthorized decryption attempts.

The system incorporates homomorphic encryption (Gentry) (522), which allows encrypted financial data to be processed without requiring decryption. This means that financial computations, audits, and risk assessments can be performed on encrypted data while maintaining confidentiality. Homomorphic encryption (522) is particularly useful for secure financial analytics, regulatory compliance, and fraud detection, as it enables financial institutions to analyze encrypted data without exposing sensitive information.

To further enhance security, the system employs cryptographic hash functions (SWIFFT) (524), which provide cryptographic hashing to verify data integrity and support secure encryption mechanisms. The hash functions (SWIFFT) (524) component ensures that encrypted data remains verifiable while preventing unauthorized modifications. The use of cryptographic hash functions (SWIFFT) (524) strengthens security by ensuring that financial transaction data cannot be altered without detection.

Thus, FIG. 5 illustrates a highly secure financial transaction architecture that integrates a multi-layered cryptographic framework, combining traditional encryption (514), lattice-based encryption (516), digital signatures (518), homomorphic encryption (522), and cryptographic hash functions (SWIFFT) (524). These elements work together to ensure that financial transaction data remains protected throughout its lifecycle, from generation to storage, processing, and transmission. By implementing post-quantum cryptographic techniques and advanced security mechanisms, the system provides a robust defense against cyber threats while ensuring compliance with modern security standards and financial regulations. This architecture is designed to be scalable, adaptable, and resilient, making it an effective solution for securing financial transactions in an era of increasing cybersecurity challenges and emerging quantum computing threats.

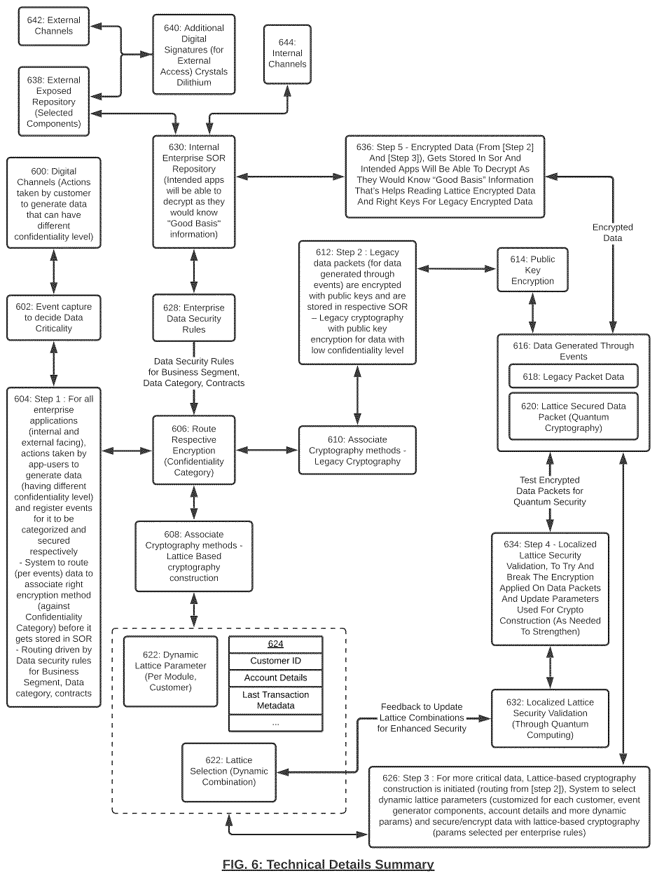

FIG. 6 provides a comprehensive technical summary of the encryption and security framework designed to protect financial transaction data using lattice-based cryptography, digital signatures, and dynamic encryption selection mechanisms. The diagram illustrates the interactions between various components responsible for encrypting, storing, validating, and securely transmitting sensitive data while ensuring compliance with enterprise security policies and quantum resistance standards. The system dynamically classifies transaction data based on confidentiality levels, applies cryptographic protections according to risk classifications, and continuously validates encryption strength against potential decryption threats. Each stage of data processing and encryption is carefully structured to ensure that sensitive financial transactions remain secure, even in the presence of emerging cryptographic challenges such as quantum computing-based attacks.

The process begins with digital channels (600), which represent different interfaces where customers interact with enterprise applications to generate financial transaction data. These digital channels include mobile banking applications, web-based financial services, enterprise banking portals, point-of-sale terminals, and regulatory compliance submission platforms. Customer actions within these digital channels generate financial data that may include transaction amounts, account identifiers, timestamps, cryptographic authentication tokens, and geolocation details. Since financial transactions can have varying degrees of confidentiality, the system must classify each data event and determine the level of encryption required before storing or transmitting the data. The event capture to decide data criticality mechanism (602) is responsible for analyzing transaction metadata and categorizing it based on predefined security policies. This categorization ensures that data with higher confidentiality requirements receives stronger cryptographic protection, while routine transactions can be encrypted using less computationally intensive methods.

Step 1 (604) describes the initial stage in which enterprise applications, both internal and external facing, process user-generated transaction data and register security events associated with financial activities. These applications capture metadata about user interactions and financial transactions, assigning a confidentiality level based on enterprise security policies. Once data confidentiality is determined, the system initiates the routing mechanism (606), which ensures that each transaction is directed to the appropriate encryption method before storage. The routing mechanism applies security rules based on various factors, including the business segment in which the transaction occurs, the data category associated with the transaction, and contractual security agreements that define access control policies. This mechanism ensures that no financial transaction is stored or transmitted without first undergoing the appropriate level of cryptographic protection.

The encryption framework consists of two primary cryptographic methodologies: legacy cryptography (610) and lattice-based cryptographic construction (608). Transactions classified as low-security follow a traditional encryption path, where they are encrypted using legacy public-key encryption methods such as RSA, ECC, or AES before being stored in enterprise repositories. Step 2 (612) describes how legacy data packets are generated from financial events and encrypted using public-key cryptography before being stored securely in the enterprise system of record. The use of legacy cryptography (614) ensures that low-risk financial transactions remain protected using well-established cryptographic standards that provide sufficient security against conventional cyber threats.

As financial transactions are processed, they are categorized into different encryption pathways based on risk classification and enterprise security policies. The system processes legacy packet data (618) for transactions that have been encrypted using conventional cryptographic methods and stored in the system of record. However, for high-security transactions, the system applies advanced encryption techniques to create a lattice-secured data packet (620), ensuring that sensitive financial data remains protected against sophisticated decryption attacks, including those enabled by quantum computing. The high-security encryption process relies on dynamic lattice parameter selection (622), which generates unique encryption parameters for each transaction based on a variety of factors. These factors include the module responsible for generating the transaction, customer identity, account details, transaction history, cryptographic authentication requirements, and enterprise-defined security rules. The lattice selection process (624) dynamically configures encryption parameters for each transaction, ensuring that encryption structures remain unique and resistant to attack.

Step 3 (626) represents the application of lattice-based cryptographic construction for high-security financial data. Transactions routed from Step 2 undergo an encryption process that dynamically selects lattice encryption parameters, ensuring that encryption remains quantum-resistant and tailored to the specific characteristics of each transaction. The lattice parameter selection follows enterprise data security rules (628), which govern how encryption methodologies are applied based on industry standards, compliance regulations, and business segment-specific security requirements. Once encrypted, financial transaction data is stored in the internal enterprise system of record repository (630), where intended applications can access it using cryptographic keys and predefined “good basis” information that facilitates authorized decryption. This security mechanism prevents unauthorized decryption attempts and ensures that only authorized financial applications can process encrypted transaction data.

Step 4 (634) introduces localized lattice security validation, a process designed to actively test the resilience of encrypted data packets against known decryption attacks. The validation process involves the use of simulated quantum computing attacks that attempt to break the encryption applied to financial data. This validation ensures that encryption parameters remain strong enough to withstand both classical and quantum decryption techniques. The test encrypted data packets for quantum security mechanism (632) continuously assesses encryption strength by applying attack simulations using algorithms such as Shor's and Grover's algorithms. If weaknesses in the encryption methodology are detected, the system dynamically updates encryption parameters to enhance security and prevent future vulnerabilities. The feedback loop from this validation process ensures that lattice encryption strategies remain adaptable and resistant to emerging cryptographic threats.

Step 5 (636) ensures that encrypted financial data from both Step 2 and Step 3 is securely stored and that intended applications can access and decrypt it using the appropriate cryptographic credentials. This security mechanism enforces enterprise authentication policies, ensuring that only applications possessing valid security keys and “good basis” decryption information can retrieve and process encrypted data. Unauthorized access attempts are blocked, and decryption requests are continuously monitored to prevent fraudulent activities.

The system also incorporates an external repository (638), which allows selected financial transaction data to be accessed by authorized third-party entities under controlled security policies. External access to encrypted data is protected using additional digital signature mechanisms (640), implemented through Crystals Dilithium, a post-quantum digital signature scheme designed to prevent unauthorized modifications and ensure data integrity. The digital signature framework verifies the authenticity of data access requests and ensures that only authorized entities can retrieve transaction records.

The final components of the system architecture include external channels (642) and internal channels (644), which define how encrypted transaction data flows within enterprise-controlled environments and external financial networks. Internal channels (644) are designed to facilitate secure data exchanges within the organization, ensuring that financial records remain protected under internal security policies. External channels (642) provide secure access to encrypted financial data for authorized financial institutions, auditors, regulatory agencies, and third-party service providers. These external channels incorporate end-to-end encryption mechanisms that ensure transaction data remains protected even when transmitted beyond enterprise-controlled networks.

Thus, FIG. 6 represents a highly sophisticated encryption and security framework that integrates multiple layers of cryptographic protection, including legacy encryption, lattice-based encryption, dynamic parameter selection, quantum-resistant security validation, and external authentication policies. The system ensures that financial transactions are classified according to their security risk, encrypted using the most appropriate cryptographic methods, and validated against emerging quantum decryption threats. By combining cryptographic adaptability with continuous security validation and authentication, the system provides a scalable and resilient approach to financial data security. The integration of lattice-based encryption ensures that transaction data remains quantum-resistant, safeguarding financial institutions from future security threats posed by advancements in quantum computing. Through the use of multi-layered encryption methodologies, real-time security validation, and controlled access mechanisms, the system offers a future-proof security model that protects sensitive financial transactions from evolving cybersecurity risks.

Pseudocode exemplars for implementing various aspects of this disclosure are set forth below with explanations for reference. The pseudocode covers data classification, encryption routing, lattice-based cryptography, dynamic lattice parameter selection, quantum security validation, digital signatures, adaptive security updates, and access control mechanisms.

### 1. Data Classification and Encryption Routing

This function classifies financial data based on its confidentiality level and routes it to the appropriate encryption method.

function classify_and_route_data(data, metadata):

```
# Step 1: Extract security-relevant metadata
confidentiality_level = assess_confidentiality(data, metadata)
security_policies = get_enterprise_security_policies(metadata)
# Step 2: Route data based on classification level
if confidentiality_level == “low”:
  encrypted_data = encrypt_with_legacy_crypto(data, metadata)
elif confidentiality_level == “high”:
  encrypted_data = encrypt_with_lattice_crypto(data, metadata)
else:
  raise Exception(“Error: Unable to classify data confidentiality level.”)
# Step 3: Store encrypted data in enterprise system of record (SOR)
store_in_sor(encrypted_data, metadata)
return encrypted_data
```

### 2. Confidentiality Assessment

This function determines the sensitivity of financial data based on enterprise security rules.

function assess_confidentiality(data, metadata):

```
  # Check for sensitive attributes in the data
  if metadata.transaction_amount > HIGH_VALUE_THRESHOLD:
    return “high”
  elif metadata.contains_personal_identifiable_info:
    return “high”
  elif metadata.transaction_type in [“wire_transfer”, “loan_approval”,
“account_update”]:
    return “high”
  else:
    return “low”
```

3. Encryption with Legacy Cryptography (for Low-Risk Data)

This function applies traditional encryption techniques.

function encrypt_with_legacy_crypto(data, metadata):

public_key = get_public_key(metadata.user_id)
encrypted_data = RSA_encrypt(data, public_key)
# Log encryption process
log_event(“Data encrypted with legacy cryptography”, metadata)
return encrypted_data

4. Encryption with Lattice-Based Cryptography (for High-Risk Data)

This function encrypts financial data using lattice-based cryptography.

function encrypt_with_lattice_crypto(data, metadata):

# Step 1: Select dynamic lattice parameters
lattice_parameters = select_dynamic_lattice_parameters(metadata)
# Step 2: Convert data into lattice vector space
data_vector = convert_to_lattice_vector(data)
# Step 3: Apply lattice encryption
encrypted_data = encrypt_using_lattice(data_vector,
lattice_parameters)
# Step 4: Store encryption details securely
store_encryption_metadata(metadata, lattice_parameters)
# Log encryption process
log_event(“Data encrypted with lattice-based
cryptography”, metadata)
return encrypted_data

### 5. Dynamic Lattice Parameter Selection

This function generates unique lattice encryption parameters for each transaction.

function select_dynamic_lattice_parameters(metadata):

```
  user_factor = hash(metadata.user_id + metadata.transaction_id)
  application_factor = hash(metadata.originating_application)
  transaction_factor = hash(metadata.transaction_amount +
  metadata.timestamp)
  # Generate unique lattice basis and noise distribution
  lattice_basis = generate_lattice_basis(user_factor, application_factor,
transaction_factor)
  noise_distribution =
  generate_noise_distribution(metadata.security_level)
  return (lattice_basis, noise_distribution)
```

### 6. Lattice-Based Encryption Function

This function encrypts data using a selected lattice structure.

function encrypt_using_lattice(data_vector, lattice_parameters):

(lattice_basis, noise_distribution) = lattice_parameters
# Apply encryption transformation
transformed_vector = apply_lattice_transformation(data_vector,
lattice_basis)
# Introduce noise for added security
encrypted_vector = add_noise_to_lattice(transformed_vector,
noise_distribution)
return encrypted_vector

### 7. Lattice-Based Decryption

This function decrypts encrypted data.

function decrypt_using_lattice(encrypted_vector, metadata):

```
  lattice_parameters = retrieve_lattice_parameters(metadata)
  # Apply inverse lattice transformation
  decrypted_vector = remove_noise_and_decrypt(encrypted_vector,
lattice_parameters)
  # Convert back to original format
  decrypted_data =
  convert_lattice_vector_to_original(decrypted_vector)
  return decrypted_data
```

### 8. Localized Lattice Security Validation

This function simulates quantum attacks to test encryption robustness.

function validate_lattice_security(encrypted_data, metadata):

```
quantum_simulation_result =
simulate_quantum_attack(encrypted_data)
if quantum_simulation_result.success:
  updated_lattice_parameters = increase_lattice_complexity(metadata)
  log_event(“Lattice encryption updated due to quantum
  vulnerability”, metadata)
  return updated_lattice_parameters
else:
  log_event(“Lattice encryption remains secure”, metadata)
  return “Secure”
```

### 9. Digital Signature Layer Using Crystals Dilithium

This function generates a digital signature for authentication.

function generate_digital_signature(data, metadata):

private_key = get_private_key(metadata.user_id)
signature = crystals_dilithium_sign(data, private_key)
return signature

### 10. External Entity Authentication Using Digital Signatures

This function authenticates external data access requests.

function authenticate_external_request(encrypted_data, external_metadata):

```
signature = retrieve_digital_signature(external_metadata)
public_key = get_public_key(external_metadata.entity_id)
if verify_digital_signature(signature, public_key):
  return decrypt_using_lattice(encrypted_data, external_metadata)
else:
  return “Unauthorized Access: Digital Signature Invalid”
```

### 11. Secure Storage in Enterprise System of Record (SOR)

This function securely stores encrypted data.

function store_in_sor(encrypted_data, metadata):

database = connect_to_sor( )
database.store(encrypted_data, metadata)
log_event(“Encrypted data stored in SOR”, metadata)

### 12. Retrieval and Decryption of Data

This function retrieves and decrypts stored encrypted data.

function retrieve_and_decrypt_data(request, metadata):

```
encrypted_data = fetch_from_sor(request.data_id)
if metadata.confidentiality_level == “low”:
  return decrypt_with_legacy_crypto(encrypted_data, metadata)
elif metadata.confidentiality_level == “high”:
  return decrypt_using_lattice(encrypted_data, metadata)
else:
  return “Error: Unauthorized access request.”
```

### 13. Adaptive Lattice Parameter Updates

This function increases encryption complexity based on threat assessment.

function increase_lattice_complexity(metadata):

```
  current_parameters = retrieve_lattice_parameters(metadata)
  new_lattice_basis =
  enhance_lattice_basis(current_parameters.lattice_basis)
  new_noise_distribution =
expand_noise_distribution(current_parameters.noise_distribution)
  return (new_lattice_basis, new_noise_distribution)
```

### 14. Quantum Attack Simulation

This function simulates attacks to test encryption robustness.

function simulate_quantum_attack(encrypted_data):

```
  quantum_computer = initialize_quantum_simulation( )
  success = quantum_computer.run_shor_algorithm(encrypted_data)
  if success:
    return { “success”: True, “message”:
    “Quantum attack successful. Increase lattice
complexity.” }
  else:
    return { “success”: False, “message”:
    “Encryption remains secure.” }
```

### 15. Enterprise Access Control Mechanism

This function enforces role-based security policies.

function enforce_access_control(request, metadata):

```
if check_user_permissions(request.user_id, metadata):
  return retrieve_and_decrypt_data(request, metadata)
else:
  return “Access Denied: Unauthorized User.”
```

In short, this sample pseudocode provides the foundation for implementing a quantum-resistant, dynamically adaptive encryption framework that protects sensitive financial data. It includes event-driven encryption selection, lattice-based security, quantum attack simulation, self-adaptive encryption updates, and enterprise-level authentication controls, ensuring the system remains secure against both classical and quantum threats.

More specifically, the pseudocode implements a sophisticated cryptographic system that dynamically classifies financial data, applies the appropriate encryption methods based on confidentiality levels, and ensures long-term security against both classical and quantum computing threats. It achieves this by integrating lattice-based encryption, dynamic lattice parameter selection, security validation mechanisms, and digital signatures for external access authentication. The system begins by classifying financial data based on security policies and metadata attributes such as transaction amount, data sensitivity, and regulatory compliance requirements. The function that performs this classification extracts metadata associated with the financial event and determines whether the data requires low-level security, which can be handled with traditional public-key encryption, or high-level security, which mandates the use of post-quantum cryptographic techniques.

Once the classification process is complete, the system routes data to the appropriate encryption method. If the data is categorized as low-risk, it is encrypted using legacy cryptography methods such as RSA, ECC, or AES. This ensures compatibility with existing financial infrastructure while providing an adequate level of protection for non-sensitive records. The encryption process retrieves the public key associated with the user or system initiating the transaction and applies RSA encryption to secure the data before storing it in the enterprise system of record. Logging mechanisms track each encryption operation to provide audit trails and facilitate compliance verification.

For highly sensitive financial data, the system applies lattice-based encryption to ensure resistance against quantum computing attacks. Before encrypting the data, the system dynamically selects lattice parameters by considering various security factors, including user identity, application origin, transaction amount, and timestamp. These factors are used to generate a unique lattice basis and noise distribution, both of which play a crucial role in securing the encrypted dataset. Unlike traditional encryption, which applies static cryptographic keys, this approach ensures that each transaction receives a unique encryption configuration, making it significantly more difficult for attackers to decrypt multiple records using the same method. The selected lattice parameters are then applied to transform the data into a vector space, after which the encryption process introduces additional noise to enhance security. The encrypted data is stored securely in the enterprise system of record along with metadata that allows authorized users to retrieve and decrypt it when necessary.

The system also incorporates a robust decryption mechanism to allow authorized applications and users to access encrypted financial records. When a request is made to decrypt data, the system retrieves the stored encryption parameters and applies the inverse transformation to reconstruct the original dataset. For lattice-encrypted data, this involves removing the noise component and converting the data from its encrypted vector format back into its original state. This process ensures that only authorized users with the correct cryptographic parameters can successfully decrypt sensitive records. Legacy-encrypted data is decrypted using the corresponding private key, ensuring that financial institutions can continue to support traditional encryption methods while transitioning to post-quantum security frameworks.

To maintain the integrity of encrypted data over time, the system incorporates a localized security validation mechanism that continuously evaluates encryption strength against potential quantum computing attacks. This mechanism simulates quantum decryption attempts using internal quantum computing simulations to test whether encrypted records remain secure under evolving computational threats. If a vulnerability is detected, the system dynamically updates lattice encryption parameters to increase complexity, ensuring that encrypted financial records remain resistant to future attacks. By automating the security validation process, the system eliminates the need for manual cryptographic updates and ensures that financial data remains protected without requiring continuous human intervention.

Another core component of the system is the digital signature mechanism, which enforces authentication and access control policies for external entities requesting access to encrypted financial records. When an external entity, such as a third-party payment processor or regulatory agency, requests access to encrypted data, the system verifies the legitimacy of the request using lattice-based digital signatures. The requesting entity must present a valid cryptographic signature generated using Crystals Dilithium, a post-quantum secure signature scheme. The system retrieves the corresponding public key and verifies the signature before granting access to the encrypted records. If the digital signature fails verification, access is denied, ensuring that unauthorized entities cannot decrypt financial data even if they gain access to encrypted files.

The system further enhances security through a dynamic key management framework that ensures cryptographic keys remain secure and accessible only to authorized applications. Unlike traditional encryption frameworks that rely on static key distribution mechanisms, this system generates and manages encryption keys dynamically based on enterprise security policies. Each encryption event generates a unique key pair, which is securely stored in a dedicated key management repository. When an authorized user or application requests decryption, the system retrieves the appropriate cryptographic key and ensures that the request meets predefined security conditions before granting access. This approach prevents unauthorized users from gaining access to cryptographic keys, thereby ensuring the integrity of encrypted financial records.

To ensure that encrypted data is stored securely, the system implements enterprise-level access control mechanisms that enforce strict security policies. When encrypted data is stored in the enterprise system of record, metadata associated with the encryption event is recorded to facilitate secure retrieval. Access control policies define which users and applications have permission to decrypt and process encrypted records based on role-based access control (RBAC) and predefined security permissions. If an unauthorized user attempts to access encrypted data, the system denies the request and logs the unauthorized access attempt for security auditing purposes.

The system also includes an adaptive encryption enhancement mechanism that dynamically increases the complexity of lattice-based encryption in response to emerging threats. If a quantum attack simulation indicates that the current encryption parameters may become vulnerable to decryption, the system automatically enhances the lattice structure by adding additional security layers. This may involve increasing the lattice basis complexity, modifying the noise distribution to introduce higher levels of randomness, or adjusting encryption settings to reinforce security. By continuously adapting encryption parameters in real time, the system ensures that financial institutions remain protected against both present and future decryption threats.

Additionally, the system supports quantum attack simulations that proactively test the strength of encrypted data against quantum computing capabilities. The quantum simulation component attempts to decrypt encrypted financial records using advanced quantum algorithms such as Shor's algorithm. If the attack simulation is successful, the system logs the vulnerability, alerts security administrators, and triggers an automatic lattice parameter update to reinforce encryption security. If the attack fails, the system logs the results and confirms that encrypted records remain secure. This proactive approach allows financial institutions to stay ahead of potential security breaches by continuously testing encryption robustness under real-world conditions.

Another integral aspect of the system is its ability to enforce enterprise-wide security policies through intelligent encryption routing decisions. When financial data is generated, the system evaluates the appropriate encryption strategy by analyzing enterprise security rules and transaction metadata. If security policies require stronger encryption for specific transaction types, such as high-value fund transfers, the system automatically applies lattice-based encryption to those transactions while allowing lower-risk transactions to be encrypted using traditional methods. This ensures that encryption policies align with business risk assessments while maintaining efficiency across all financial operations.

By combining lattice-based encryption, digital signatures, quantum security validation, dynamic key management, and enterprise access controls, the system provides a comprehensive security solution for financial institutions. The design ensures that encrypted data remains protected at all times, whether at rest in storage, in transit between financial systems, or accessed by authorized users. The automation of encryption processes, self-adapting security validation, and continuous cryptographic enhancement mechanisms ensure that financial data remains resilient against both classical and quantum cybersecurity threats.

A skilled artisan, upon reviewing the disclosure, will appreciate that the systems and methods described can be subject to numerous alternatives, modifications, combinations, and customizations while remaining within the spirit and scope of the disclosure. One possible alternative is the use of different lattice-based cryptographic schemes beyond the primary Crystals Dilithium and Kyber algorithms. Variants such as NTRU, FrodoKEM, or Saber could be integrated into the encryption framework.

Another modification involves adjusting the dynamic lattice parameter selection mechanism to include additional security factors beyond user identity, transaction type, and metadata attributes. These parameters could incorporate geolocation data, device fingerprinting, behavioral analytics, or real-time threat intelligence feeds to enhance the granularity of encryption parameter customization.

An alternative approach to storing encrypted data in the enterprise system of record could involve decentralized or distributed ledger technology. Instead of relying on a centralized database, encrypted records could be securely stored across a blockchain network, ensuring immutable transaction integrity while maintaining post-quantum cryptographic security. Smart contracts could be leveraged to enforce access controls, enabling conditional decryption based on enterprise policies and regulatory compliance requirements.

A further modification could involve customizing the security validation mechanism to assess encryption robustness using a broader set of quantum attack simulations. While Shor's algorithm is the primary concern for breaking traditional public-key encryption, future quantum algorithms may emerge that pose additional risks to lattice-based cryptographic methods. The lattice encryption system can also be customized to support hybrid cryptographic models, where traditional encryption methods are used alongside lattice-based encryption to provide layered security.

Another alternative involves extending the digital signature framework to incorporate biometric authentication for additional security in verifying external access requests. Instead of relying solely on Crystals Dilithium signatures, an external entity seeking access to encrypted records could have to provide biometric proof, such as facial recognition or fingerprint authentication, combined with the digital signature.

The encryption key management system could be modified to support secure multi-party computation (MPC) or threshold cryptography techniques. Instead of relying on a centralized key repository, the system could distribute cryptographic keys across multiple nodes or entities within a financial institution. Only when a predefined threshold of authorized parties collaborate would the decryption key be reconstructed.

A further customization could involve implementing additional layers of post-quantum secure access control policies that dynamically adjust decryption permissions based on evolving security conditions. For instance, the system could incorporate contextual access control, where decryption permissions are granted based on factors such as real-time network security status, time of day, location, or ongoing cybersecurity threat intelligence reports.

The localized security validation mechanism could be extended to function as a decentralized cryptographic integrity verification network. Instead of relying solely on internal security validation methods, financial institutions could participate in a collaborative security network where encryption strength assessments are conducted across multiple organizations.

Modifications to the digital signature authentication framework could also include the use of zero-knowledge proofs to further enhance privacy while ensuring authentication. Another customization could involve integrating homomorphic encryption into the system to allow computations to be performed on encrypted financial records without requiring decryption.

Another alternative would be to integrate post-quantum encryption with quantum key distribution (QKD) protocols for enhanced cryptographic security.

Although the present technology has been described based on what is considered the most practical and preferred implementations, it is to be understood this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for securing financial data using lattice-based cryptography and dynamic encryption selection, the method comprising:
receiving, by a data classification module, a data transaction request including transaction metadata and financial data associated with a user;
analyzing, by the data classification module, the transaction metadata to determine a confidentiality classification of the financial data based on enterprise security policies, the confidentiality classification being one of a low-security classification or a high-security classification;
selecting, by an encryption routing module, an encryption method for securing the financial data based on the confidentiality classification, wherein selecting comprises:
(i) when the confidentiality classification is the low-security classification, applying legacy encryption to the financial data using a public-key encryption algorithm; and
(ii) when the confidentiality classification is the high-security classification, initiating a lattice-based encryption process for the financial data;
generating, by a lattice parameter selection module, dynamic lattice parameters customized based on at least one of user identity, transaction type, transaction amount, and data origin module, wherein generating comprises:
(i) determining a lattice basis using a combination of transaction-specific metadata and enterprise-defined encryption policies; and
(ii) generating a noise distribution function specific to the financial data to ensure security against quantum decryption attacks;
encrypting, by a lattice encryption module, the financial data using the dynamic lattice parameters, wherein encrypting comprises:
(i) transforming the financial data into a lattice vector representation;
(ii) applying the lattice basis and the noise distribution function to the lattice vector representation to generate an encrypted lattice structure; and
(iii) storing the encrypted lattice structure in an enterprise system of record along with metadata identifying the encryption parameters;
validating, by a security validation module, the strength of the encrypted lattice structure using a quantum attack simulation, wherein validating comprises:
(i) executing a quantum decryption attempt using simulated quantum computing algorithms;
(ii) analyzing results of the quantum decryption attempt to determine whether the encrypted lattice structure is susceptible to decryption; and
(iii) when the encrypted lattice structure is determined to be susceptible, adjusting the dynamic lattice parameters by increasing lattice complexity and modifying noise distribution;
storing, by a secure storage module, the encrypted financial data in an enterprise database configured to enforce access control policies for decryption requests;
receiving, by an external access control module, a decryption request from an external entity to access the encrypted financial data, the decryption request including an authentication signature;
authenticating, by a digital signature verification module, the external entity based on the authentication signature, wherein authenticating comprises:
(i) verifying the authentication signature using a lattice-based digital signature scheme; and
(ii) authorizing access to the encrypted financial data upon successful verification of the authentication signature;
retrieving, by a secure access module, the encrypted financial data from the enterprise database in response to the authorized decryption request;
decrypting, by a lattice decryption module, the encrypted financial data using the corresponding lattice parameters, wherein decrypting comprises:
(i) applying an inverse lattice transformation to convert the encrypted lattice structure into a lattice vector representation;
(ii) removing the noise distribution function from the lattice vector representation; and
(iii) reconstructing the original financial data from the decrypted lattice vector representation; and
providing, by an access delivery module, the decrypted financial data to the external entity in response to the authorized decryption request, thereby ensuring that access to sensitive financial information is secured against both classical and quantum cryptographic attacks.

2. The method of claim 1, wherein analyzing the transaction metadata to determine the confidentiality classification further comprises applying a machine learning model trained on historical transaction data to dynamically assess risk levels associated with the financial data.

3. The method of claim 2, wherein the machine learning model is trained using at least one of user transaction patterns, fraud detection indicators, geolocation data, device fingerprints, and real-time cybersecurity threat intelligence.

4. The method of claim 3, wherein selecting the encryption method further comprises dynamically adjusting the encryption method based on a real-time risk score generated by the machine learning model, wherein a higher risk score increases the complexity of the selected encryption method.

5. The method of claim 4, wherein generating the dynamic lattice parameters further comprises selecting a lattice dimension and modulus based on the confidentiality classification, wherein higher-security classifications result in larger lattice dimensions and higher modulus values.

6. The method of claim 5, wherein the noise distribution function used in the lattice-based encryption process is modified based on an adaptive security model that continuously refines noise levels in response to evolving quantum computing threats.

7. The method of claim 6, wherein validating the encrypted lattice structure further comprises executing a plurality of simulated quantum decryption attempts using different quantum attack models, including but not limited to Shor's algorithm and Grover's search algorithm.

8. The method of claim 7, wherein adjusting the dynamic lattice parameters in response to a successful quantum decryption attempt further comprises applying a security reinforcement algorithm that iteratively increases the lattice complexity until quantum attack simulations fail to break the encryption.

9. The method of claim 8, wherein authenticating the external entity further comprises applying a multi-factor authentication process, wherein the external entity must provide at least two authentication factors selected from a cryptographic key, a biometric identifier, a time-sensitive authentication code, or a blockchain-verified identity signature.

10. The method of claim 9, wherein providing the decrypted financial data to the external entity further comprises encrypting the decrypted financial data using a homomorphic encryption scheme to enable computations to be performed on the data while maintaining its confidentiality before final decryption by the external entity.

11. A method for securing financial data using lattice-based cryptography, dynamic encryption selection, adaptive security validation, and authenticated access control, the method comprising:
receiving, by a data classification module, a data transaction request including transaction metadata and financial data associated with a user, the transaction metadata comprising at least a transaction type, a transaction amount, an originating application identifier, and a user identifier;
analyzing, by the data classification module, the transaction metadata to determine a confidentiality classification of the financial data based on enterprise security policies, wherein analyzing comprises applying a machine learning model trained on historical transaction data to dynamically assess risk levels associated with the financial data, the machine learning model trained using at least one of user transaction patterns, fraud detection indicators, geolocation data, device fingerprints, and real-time cybersecurity threat intelligence;
selecting, by an encryption routing module, an encryption method for securing the financial data based on the confidentiality classification and the dynamically assessed risk level, wherein selecting comprises:
(i) when the confidentiality classification is a low-security classification, applying legacy encryption to the financial data using a public-key encryption algorithm; and
(ii) when the confidentiality classification is a high-security classification, initiating a lattice-based encryption process for the financial data, wherein the complexity of the selected encryption method is increased in response to a higher risk score generated by the machine learning model;
generating, by a lattice parameter selection module, dynamic lattice parameters customized based on at least one of the user identifier, the transaction type, the transaction amount, the originating application identifier, and the confidentiality classification, wherein generating comprises:
(i) selecting a lattice dimension and modulus based on the confidentiality classification, wherein higher-security classifications result in larger lattice dimensions and higher modulus values;
(ii) determining a lattice basis using a combination of transaction-specific metadata and enterprise-defined encryption policies; and
(iii) generating a noise distribution function specific to the financial data, wherein the noise distribution function is modified based on an adaptive security model that continuously refines noise levels in response to evolving quantum computing threats;
encrypting, by a lattice encryption module, the financial data using the dynamic lattice parameters, wherein encrypting comprises:
(i) transforming the financial data into a lattice vector representation;
(ii) applying the lattice basis and the noise distribution function to the lattice vector representation to generate an encrypted lattice structure; and
(iii) storing the encrypted lattice structure in an enterprise system of record along with metadata identifying the encryption parameters;
validating, by a security validation module, the strength of the encrypted lattice structure using a quantum attack simulation, wherein validating comprises:
(i) executing a plurality of simulated quantum decryption attempts using different quantum attack models, including but not limited to Shor's algorithm and Grover's search algorithm;
(ii) analyzing results of the quantum decryption attempts to determine whether the encrypted lattice structure is susceptible to decryption; and
(iii) when the encrypted lattice structure is determined to be susceptible, adjusting the dynamic lattice parameters by applying a security reinforcement algorithm that iteratively increases the lattice complexity until quantum attack simulations fail to break the encryption;
storing, by a secure storage module, the encrypted financial data in an enterprise database configured to enforce access control policies for decryption requests;
receiving, by an external access control module, a decryption request from an external entity to access the encrypted financial data, the decryption request including an authentication signature and at least two authentication factors selected from a cryptographic key, a biometric identifier, a time-sensitive authentication code, or a blockchain-verified identity signature;
authenticating, by a digital signature verification module, the external entity based on the authentication signature and authentication factors, wherein authenticating comprises:
(i) verifying the authentication signature using a lattice-based digital signature scheme; and
(ii) authorizing access to the encrypted financial data upon successful verification of the authentication signature and at least one additional authentication factor;
retrieving, by a secure access module, the encrypted financial data from the enterprise database in response to the authorized decryption request;
decrypting, by a lattice decryption module, the encrypted financial data using the corresponding lattice parameters, wherein decrypting comprises:
(i) applying an inverse lattice transformation to convert the encrypted lattice structure into a lattice vector representation;
(ii) removing the noise distribution function from the lattice vector representation; and
(iii) reconstructing the original financial data from the decrypted lattice vector representation;
encrypting, by a post-decryption security module, the decrypted financial data using a homomorphic encryption scheme before transmission to the external entity, wherein the homomorphic encryption scheme enables computations to be performed on the encrypted financial data while maintaining its confidentiality; and
providing, by an access delivery module, the homomorphically encrypted financial data to the external entity in response to the authorized decryption request, thereby ensuring that access to sensitive financial information is secured against both classical and quantum cryptographic attacks.

12. A system for securing financial data using lattice-based cryptography, dynamic encryption selection, adaptive security validation, and authenticated access control, the system comprising:
one or more processors; and a non-transitory computer-readable memory coupled to the one or more processors and storing instructions that, when executed by the one or more processors, cause the system to perform operations having:
a data classification module that receives a data transaction request including transaction metadata and financial data associated with a user, the transaction metadata comprising at least a transaction type, a transaction amount, an originating application identifier, and a user identifier, and to analyze the transaction metadata to determine a confidentiality classification of the financial data based on enterprise security policies, wherein the data classification module applies a machine learning model trained on historical transaction data to dynamically assess risk levels associated with the financial data, the machine learning model trained using at least one of user transaction patterns, fraud detection indicators, geolocation data, device fingerprints, and real-time cybersecurity threat intelligence;
an encryption routing module that selects an encryption method for securing the financial data based on the confidentiality classification and the dynamically assessed risk level, wherein the encryption routing module:
(i) applies legacy encryption to the financial data using a public-key encryption algorithm when the confidentiality classification is a low-security classification; and
(ii) initiates a lattice-based encryption process for the financial data when the confidentiality classification is a high-security classification, wherein the encryption routing module increases the complexity of the selected encryption method in response to a higher risk score generated by the machine learning model;
a lattice parameter selection module that generates dynamic lattice parameters customized based on at least one of the user identifier, the transaction type, the transaction amount, the originating application identifier, and the confidentiality classification, wherein the lattice parameter selection module:
(i) selects a lattice dimension and modulus based on the confidentiality classification, wherein higher-security classifications result in larger lattice dimensions and higher modulus values;
(ii) determines a lattice basis using a combination of transaction-specific metadata and enterprise-defined encryption policies; and
(iii) generates a noise distribution function specific to the financial data, wherein the noise distribution function is modified based on an adaptive security model that continuously refines noise levels in response to evolving quantum computing threats;
a lattice encryption module that encrypts the financial data using the dynamic lattice parameters, wherein the lattice encryption module:
(i) transforms the financial data into a lattice vector representation;
(ii) applies the lattice basis and the noise distribution function to the lattice vector representation to generate an encrypted lattice structure; and
(iii) stores the encrypted lattice structure in an enterprise system of record along with metadata identifying the encryption parameters;
a security validation module that validates the strength of the encrypted lattice structure using a quantum attack simulation, wherein the security validation module:
(i) executes a plurality of simulated quantum decryption attempts using different quantum attack models, including but not limited to Shor's algorithm and Grover's search algorithm;
(ii) analyzes results of the quantum decryption attempts to determine whether the encrypted lattice structure is susceptible to decryption; and
(iii) when the encrypted lattice structure is determined to be susceptible, applies a security reinforcement algorithm that iteratively increases the lattice complexity until quantum attack simulations fail to break the encryption;
a secure storage module that stores the encrypted financial data in an enterprise database configured to enforce access control policies for decryption requests;
an external access control module that receives a decryption request from an external entity to access the encrypted financial data, the decryption request including an authentication signature and at least two authentication factors selected from a cryptographic key, a biometric identifier, a time-sensitive authentication code, or a blockchain-verified identity signature;
a digital signature verification module that authenticates the external entity based on the authentication signature and authentication factors, wherein the digital signature verification module:
(i) verifies the authentication signature using a lattice-based digital signature scheme; and
(ii) authorizes access to the encrypted financial data upon successful verification of the authentication signature and at least one additional authentication factor;
a secure access module configured to retrieve the encrypted financial data from the enterprise database in response to the authorized decryption request;
a lattice decryption module that decrypts the encrypted financial data using the corresponding lattice parameters, wherein the lattice decryption module:
(i) applies an inverse lattice transformation to convert the encrypted lattice structure into a lattice vector representation;
(ii) removes the noise distribution function from the lattice vector representation; and
(iii) reconstructs the original financial data from the decrypted lattice vector representation;
a post-decryption security module that encrypts the decrypted financial data using a homomorphic encryption scheme before transmission to the external entity, wherein the homomorphic encryption scheme enables computations to be performed on the encrypted financial data while maintaining its confidentiality; and
an access delivery module that provides the homomorphically encrypted financial data to the external entity in response to the authorized decryption request, thereby ensuring that access to sensitive financial information is secured against both classical and quantum cryptographic attacks.

13. The system of claim 12, wherein the data classification module further applies a real-time anomaly detection model to compare the transaction metadata against historical transaction patterns to identify potentially fraudulent transactions before encryption selection.

14. The system of claim 13, wherein the encryption routing module further selects a hybrid encryption method when the transaction metadata indicates a medium-security classification, wherein hybrid encryption comprises encrypting the financial data using both a public-key encryption algorithm and a lattice-based encryption algorithm to provide layered security.

15. The system of claim 14, wherein the lattice parameter selection module further customizes the dynamic lattice parameters based on real-time cybersecurity threat intelligence data, wherein the threat intelligence data includes known cryptographic attack vectors and active quantum computing developments.

16. The system of claim 15, wherein the security validation module further comprises a multi-tiered security assessment framework, wherein the multi-tiered security assessment framework applies different levels of quantum attack simulations based on enterprise security policies, including standard, enhanced, and critical security validation levels.

17. The system of claim 16, wherein the secure storage module further comprises a distributed storage architecture, wherein encrypted financial data is stored redundantly across multiple secure enterprise storage nodes to ensure data integrity and prevent unauthorized centralized access.

18. The system of claim 17, wherein the external access control module further enforces a geo-fencing security policy that restricts decryption requests based on the geographical location of the external entity, wherein decryption requests originating from unauthorized geographic regions are denied.

19. The system of claim 18, wherein the digital signature verification module further includes a blockchain-based verification mechanism, wherein authentication signatures are recorded on an immutable blockchain ledger to provide tamper-resistant authentication tracking for external decryption requests.

20. The system of claim 19, wherein the access delivery module further encrypts the homomorphically encrypted financial data using a transport layer security protocol before transmission to the external entity, ensuring end-to-end security for sensitive financial data during network communication.
